(19) United States
(12) Patent Application Publication
(10) Pub. No.: US 2004/0117777 A1
(43) Pub. Date: Jun. 17, 2004

(54) Systems and methods for land-use development, planning and management

(76) Inventor: Daniel De Lichana, Verrieres La Buisson (FR)

Correspondence Address: ANDREWS KURTH L.L.P., 1701 PENNSYLVANIA AVENUE, N.W. SUITE 300, WASHINGTON, DC, 20006, US

(21) Appl. No.: 10/617,829

(22) Filed: Jul. 14, 2003

Related U.S. Application Data
(60) Provisional application No. 60/395,312, filed on Jul. 12, 2002.
(60) Provisional application No. 60/443,575, filed on Jan. 30, 2003.

(51) Int. Cl. G06F 9/45

(52) U.S. Cl. 717/151; 717/160; 717/162

(57) ABSTRACT

In systems and methods for land-use development, planning and management, the creation of an organized environment evolving in time and space is disclosed. The system and method is sustained by a smart infrastructure centrally or de-centrally managed to link, in a given perimeter, on developed or undeveloped sites, private and/or public equipments and deliver services to customers that generate a quality of life based on qualified and quantified parameters. The systems and methods use a definition of services and an open architecture, flexible and scalable to integrate social, economic and technology changes. In one embodiment, a framework is used to propose or offer services.

### CROSS-REFERENCE TO RELATED APPLICATION

The priority of the Jul. 12, 2002 filing date of U.S. Provisional Application Serial No. 60/395,312; and the Jan. 30, 2003, filing date of U.S. Provisional Application Serial No. 60/443,575 is hereby claimed. U.S. Provisional Applications Serial Nos. 60/395312 and 60/443,575 are hereby incorporated herein by reference.

### TECHNICAL FIELD

The technical field is land-use development and management.

### BACKGROUND

Our urban/suburban and rural landscape initially was a mosaic of the components of our daily life. Yet in the 20^{th} century the separation between the functions of “life” “work” and “play” has been prevalent. This modification in our approach to land-use has had a perverse effect on the evolution of our towns, suburbs and country side. The urban/suburban/rural land use problems have been treated mostly through a mono-disciplinary approach. Land-use planning has been mostly through zoning (offices, individual or collective habitat, recreational, inexpensive or luxurious) influenced by this separation of function. The value of a site as determined by the type of land-use has also been influenced by this separation of functions.

The interaction between human and technological evolution is at the root of our civilizations. Our way of life is a reflection of this interaction and our landscape must offer the flexibility to integrate harmoniously social, cultural, ethical and technological evolutions in a secured, high-performance system. A multifunction approach to land use is needed.

A transverse and multi-disciplinary approach to the management of the environment is needed. An integrated approach to offer security, familial and collective quality of life, cultural and artistic resources, natural settings and open spaces, places of worship, education, and services to the citizen is needed.

What is needed is a system and method for improving land use, use of physical space, and/or neighborhoods.

What is needed is a system and method for improving the quality of life in a given physical space or neighborhood.

What is needed is a system and method for improving the quality of life evolving in time.

What is needed is systems and methods for improving the quality of life built from the consumers perspective; from the ground-up focused on the consumer; and/or with consumer in mind.

What is needed is a system and method for planning which accepts consumer or customer feedback.

What is needed is a system and method for modifying and/or managing the environment and structure of a community to improve quality of life.

What is needed is a system and method which defines environmental factors, public and/or private infrastructure and/or organizational structure and other intangibles or “services,” for the customers.

What is needed is a system and method for delivering and/providing services to customers/consumers that generates and/or improves upon a quality of life.

What is needed is a system and method for identifying quantified and/or qualified parameters for defining, quantifying, and/or qualifying quality of life.

What is needed is a methodology, algorithm, set of equations, and/or steps to quantify and/or qualify a quality of life in a given physical space.

What is needed is a system and method for managing quality of life.

What is needed is a system and method for effecting change and/or improving upon quality of life.

What is needed is a system and method for managing, effecting change, and/or improving upon the results of an analysis of quantified and/or qualified parameters related to quality of life.

What is needed is a system and method for optimizing land use, use of a physical space, and/or neighborhoods.

What is needed is a graphical method of representing quality of life.

What is needed is are systems and methods for identifying services that are being provided to consumers of a neighborhood or physical space.

What is needed are systems and methods for identifying services that could be offered to consumers of a neighborhood or physical space.

What is needed are systems and methods for providing “neighborhood” services or packaged services to consumers.

What is needed are systems and methods for managing “neighborhood” services or packaged services provided to consumers.

What is needed are systems and methods for improving the services or packaged services provided or offered to consumers.

What is needed is a system and method for identifying private infrastructure and public infrastructure (physical and/or organizational structure).

What is needed is a system and method for identifying interstitial environs and/or surrounding environs of private and public infrastructures.

What is needed is a system and method for identifying or creating links between and/or among private infrastructure and/or public infrastructure.

What is needed is a system for analyzing these links.

What is needed is a system and method for managing these links.

What is needed is a graphical method for displaying these links.

What is needed is 3D or virtual reality tours of proposed neighborhoods or services.

### SUMMARY

The Systems and Methods For Land-Use Development, Planning and Management allows the creation of an organized environment evolving in time and space sustained by a smart infrastructure centrally or de-centrally managed to link, in a given perimeter, on developed or undeveloped sites, private and/or public equipments and delivery of services to customers that generate a quality of life based on qualified and quantified parameters.

The Systems and Methods For Land-Use Development, Planning and Management uses a definition of “services” and an open architecture, flexible and scalable to integrate social, economic and technology changes. In one embodiment, a framework is used to propose or offer services.

Preferred embodiments include, for example, a plurality of structures (e.g., organized as a neighborhood) linked according to definition, a system for providing Systems and Methods For Land-Use Development, Planning and Management tools, a methodology of and system for linking a plurality of structures according to the Systems and Methods For Land-Use Development, Planning and Management definition, a method of providing the Systems and Methods For Land-Use Development, Planning and Management tools, and a computer-readable medium with instructions to perform such methods.

One of the advantages of the system and methods is to please the consumer or to take the consumers point of view in land-use, or developing a neighborhood or organized environment. The systems and methods focus on the consumer. Environmental factors, public and private infrastructure are considered services for the consumer.

One way to accomplish this is to measure consumer satisfaction with services or to account for the consumer's desires. In one embodiment, this is done by measuring or defining quality of life. The quality of life is measured or defined based upon quantified and/or qualified parameters. In one embodiment, quality of life if measured by quantifying it on a scale, for example, it is measured on a scale of one to ten.

Using this measurement of quality of life, algorithms and equations may be used to determine the cost to improve quality of life. For example, if a given set of existing data provides a quality of life of 3 on a scale of one to ten, then a set of changes can be identified that would increase the quality of life to 4. Then, that set of changes can be priced to determine the cost of increasing the quality of life in a given neighborhood from three to four. The measurement for the quality of life can broken into categories. For example, eight sectors may be used and each category may be measured on a scale of one to one hundred.

Even as it relies heavily on systems shaped by information technology, the Systems and Methods For Land-Use Development, Planning and Management integrates a transversal approach to the management of the environment to offer security, familial and collective quality of life, cultural and artistic resources, natural settings and open spaces, places of worship, education, and services to the citizen. The transversal and multidisciplinary approach of this non-exhaustive list of daily functions in towns, cities, counties and/or regions creates economies of scale through the optimal implementation, operation and management of existing and/or new services proposed to the citizen by traditional or totally new structures generating profits and employment.

The Systems and Methods For Land-Use Development, Planning and Management uses a global, multidisciplinary and transverse approach to land-use and management, for “normal” or “extreme” site development for a given population taking into account evolutions factors within a defined time period. To illustrate these three dimensions, three axes X, Y, and Z, are used to represent a set of service data: The interaction between the components determines qualifiable and quantifiable results. The computation of these interactions allows the optimum programming of the evolution of the given space. It is translated in practice and on site by the usual land-use tools. The retained interaction can be illustrated on the 3 axes with codified symbols and objectively figures a precise environment with symbolic versus graphic readings.

The Systems and Methods For Land-Use Development, Planning and Management develops the symbolic illustration by applying it to a site through numeric images so that the maximum number of concerned stakeholders who might not always possess the capacity to understand an abstract reading can apprehend the result of the evolution programming of the environment from their own perspective through a journey in the proposed or retained virtual environment.

The Systems and Methods For Land-Use Development, Planning and Management has created a shift in paradigm over existing systems. The parameters that compose an environment are considered as services. Services are defined as the passage from static to dynamic actions of any entity, or the typology of classification of the parameters of natural and/or man-made objects, that allows a community to perform tasks owed to individuals or the public of certain tasks, obligations, or duties in an organized structure. This shift in paradigm liberates land-use initiators from the traditional mode of thinking by apprehending and studying the combination of elements once considered static and manipulating them dynamically. In doing so the environment and the structure of a community can be modified within set objectives to resolve issues in the eight sectors in any climate—temperate or extreme, in any milieu—underwater, earth, space—for any applicability—civil or military. Included in the definition of services are tangible and intangible parameters that constitute public space, equipment, content, traditional services and identical private parameters inasmuch as they are part of a collective environment. Therefore parameters such as a bridge, a river, a street, streetlights, apartments, TV channels, agriculture, public health, a building, the city hall, the state, sports, a book, a field, offices, cattle, a forest, air and water quality, noise, a factory, the coast, a hill, the profile of the population, age categories, etc. are considered as service parameters. Personal individual data such as spirituality, faith are not included otherwise than through their materialistic expression such as a church, temple, and synagogue.

These services are categorized thematically in eight sectors: Smart Growth and Sustainable Development; Security; Health Care; Education; Environment; Transportation; Culture and Sports; and Information and Communication. There are three categories of services: 1) Those that are known and can be optimized (C1); 2) those that can be extrapolated from existing technologies and services (C2); and 3) those that can only be imagined (C3). The existing and/or obsolete services (C0) are taken into account in the computation level and represented in the assessment grid. The services are organized through a services database, open to the client. The database is increased constantly and renewed in real time. Therefore, the virtual solutions to be combined tend to infinity.

Land-use is to be understood as: urban/suburban/rural/natural/man-made and use as: as-is or transformed by planning, development and/or management. The methodology is based on a 3D approach to land-use, which combines interactively 1) human, 2) economic, and 3) environmental factors. The combination of land-use data is presented and organized as services in order to offer an array of choices for a quality of life based on qualified and quantified parameters. Data may be broken down in 8 or more sectors: Smart Growth and Sustainable Development; Security; Health Care; Education; Environment; Transportation; Culture and Sports; Information and Communication. Therefore each land-use site may be different both in terms of its make-up and objectives.

In one embodiment, the framework or infrastructure identifies and defines the links.

In one embodiment, the framework or infrastructure manages the links. This management may be done centrally or de-centrally.

In one embodiment each of the systems or subsystems described as embodiments above is used together in a sequential or dynamic fashion.

The principle tools to implement the Systems and Methods For Land-Use Development, Planning and Management solution are based on methodologies sustained by a software suite and visualized through a 3D virtual reality tool. The Systems and Methods For Land-Use Development, Planning and Management were developed from an empirical approach based on actual site implementation. The Systems and Methods For Land-Use Development, Planning and Management are based on the following principles:

1) The methodology serves as the basis to imagine and create services through evolutions and innovations in the aforementioned eight sectors;

2) the methodology is supported by software, which develops, and tests a series of combined parameters created to reflect the choices made by the community; and

3) these combinations can vary in large quantity, based on the software calculations from a tri-dimensional interactive grid depending on the data of the given environment, considered and organized as services to allow the choices for a determined quality of life resulting from this combination.

The methodology is based on 4 phases: Land-Use Conceptualization: theoretical and modeling; Land-Use Implementation; Land-Use Management and Maintenance; and Land-Use Controls. The phases are interactive, yet can be used independently. The software suite that operates the Systems and Methods For Land-Use Development, Planning and Management is based on a sequential approach to the methodology. The suite follows the 4 major phases of the methodology, however each part is interactive and can be used independently. In addition, a 3D virtual reality tool allows all stakeholders to visualize the future chosen environment and its impact as compared to present land-use.

In one aspect, the Systems and Methods For Land-Use Development, Planning and Management is a framework for optimizing use of resources in a physical space comprising: links that link entities, having a relationship with a physical space, where the links define a relationship between two or more entities or between an entity and the physical space; and a feedback loop that allows user input or consumer feedback to be used in order to optimize one of consumer satisfaction and quality of life in services offered or proposed to be offered to consumers located in the physical space.

In another aspect, the Systems and Methods For Land-Use Development, Planning and Management is a method for optimizing land and resource use, comprising the steps of: gathering data, where the data is representative of human factors, economic factors and environmental factors; qualitatively assessing the data; quantitatively assessing the data; developing a plan for optimal use of the land and resources, wherein the step of developing comprises determining a numerical representation or value of services, formulating a theoretical specification, and modeling the services and use of the land and resources; and repeating the steps of gathering data, qualitatively assessing the data, quantitatively assessing the data, and developing a plan, where the step of repeating aids in creating an optimal land-use plan.

In yet another aspect, the Systems and Methods For Land-Use Development, Planning and Management is a computer-readable medium comprising instructions to: gather data, where the data is representative of human factors, economic factors and environmental factors; qualitatively assess the data; quantitatively assess the data; develop a plan for optimal use of the land and resources, where the step of develop a plan comprises determining a numerical representation or value of services, formulating a theoretical specification, and modeling the services and use of the land and resources; and repeat the steps of gather data, qualitatively assess the data, quantitatively assess the data, and develop a plan, where the step of repeating aids in creating an optimal land-use plan.

It is an advantage of one embodiment to provide the consumer with the most appropriate packages of services within monetary constraints. The consumer or customer is the resident or user of the physical space. The environment is a package of service provided or delivered to the consumer. The parameters that compose an environment are services. The more robust the service package or offering of services, the higher quality of the service package, and the better fit between the service package and the consumer.

It is an advantage of one embodiment to account for the natural environment, economic realities, ethics issues, and legal issues.

It is an advantage of one embodiment to include service parameters such as: smart growth development, security, health care, education, environment, transportation, cultural life and sport, information and communications.

It is an advantage of one embodiment to provide visual and graphical displays of results of the system and methods.

It is an advantage of one embodiment to provide a 3D assessment grid.

It is an advantage of one embodiment to provide a theoretical specification of possible future land use.

It is an advantage of one embodiment to compare theoretical with present land use and highlight incompatibilities.

It is an advantage of one embodiment to simulate services, service packages and/or neighborhoods.

It is an advantage of one embodiment to propose services.

It is an advantage of one embodiment to use customer or consumer feedback.

It is an advantage of one embodiment to optimize proposed or actual services.

It is an advantage of one embodiment to reduce global cost to investors and the community.

It is an advantage of one embodiment to ensure greater budget planning and control.

It is an advantage of one embodiment to provide operational specifications to implement land-use and dynamic land-use.

It is an advantage of one embodiment to provide virtual reality presentation land-use.

It is an advantage of one embodiment to provide 3D journey for land-use.

The preferred embodiments are described below in the Figures and Detailed Description. Unless specifically noted, it is applicants' intention that the words and phrases in the specification and claims be given the ordinary and accustomed meaning to those of ordinary skill in the applicable art(s). If the applicants intend any other meaning, they will specifically state they are applying a special meaning to a word or phrase.

### DESCRIPTION OF THE DRAWINGS

The detailed description will refer to the following drawings, wherein like numerals refer to like elements, and wherein:

FIG. 1 shows the infrastructure of the Systems and Methods For Land-Use Development, Planning and Management that is used to provide services to consumers and or customers;

FIG. 2 is another embodiment of the infrastructure and shows that entities have relationships, associations, or links to the physical space;

FIG. 3 is a flow diagram of an embodiment of the various phases of land-use;

FIG. 4 is a flow chart diagram illustrating one embodiment of a method for land-use development, planning and management;

FIG. 5 is an illustration of the specification chart tool;

FIGS. 6A-6E illustrate the grid tool;

FIGS. 7A-7H illustrate the applications of the Systems and Methods For Land-Use Development, Planning and Management during Phase 1;

FIGS. 8A-8C illustrate the applications of the Systems and Methods For Land-Use Development, Planning and Management during Phase 2;

FIGS. 9A-9D illustrate the applications of the Systems and Methods For Land-Use Development, Planning and Management during Phase 3; and

FIGS. 10A-10B illustrate the applications of the Systems and Methods For Land-Use Development, Planning and Management during Phase 4.

### DETAILED DESCRIPTION

An organizational structure or framework is disclosed that identifies or defines links between/among entities (both public & private including their infrastructures) and their surrounding environs, which can assist in the offering and/or delivery of services and which can be used to optimize the quality of life of consumers in a geographic area (or physical space), during a specific period of time. Preferably, the framework manages these links and acts as a tool to assist in the delivery of services to consumers that generates a quality of life. In some embodiments this management is dynamic and the system can be used to optimize the quality of life or customer satisfaction with the services.

### I. A SHIFT IN PARADIGM

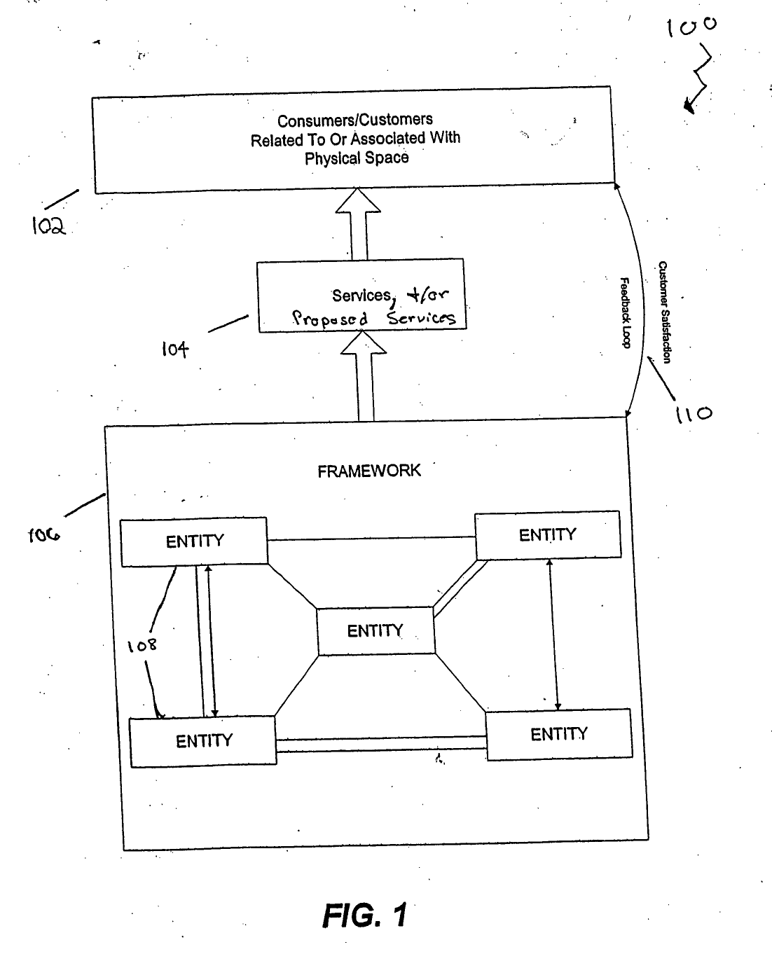

With reference now to FIG. 1 of the drawings there is illustrated therein a network of entities, services and consumers/customers, generally designated by the reference numeral 100. The network 100 is comprised of various consumers/customers 102, a framework 106, entities 108, and services 104. The consumers/customers 102 may be related to or associated with a physical space. Examples of such physical spaces may include a neighborhood, a town or a large metropolitan city.

The services 104 that that are provided may range from a wide variety of services that consumers/customers 102 use in their everyday lives in the environments in which they live. These services may be public services or private services. For example, public services may include multimedia information and communication services, a decentralized network hub, satellite telecommunications, telecenter, technical equipment telemanagement, dynamic views, residential housing, electrical cars recharge terminal, interactive terminal, environmental information, assistance to the blind, multimedia cable network, “technology follies,” monetic, consumer teleservice, multimedia network/teledistribution, or a local network. As seen by the above list, in the context of land use and development, services should not be limited to the traditional sense, but should include all aspects of one's quality of life. For example, dynamic views of a residential housing are services in this sense in that these aspects of land-use enhance one's quality of life.

Other public services may include passive security and telesecurity services, video surveillance, technical equipment management, interactive terminal/emergency, systematic cleaning of public areas, urban furniture, green space management, anti-tagging facing, selective access to private areas, and night urban development services, public lighting telemanagement, fiber optic network, lighted paths, automatic lighting management, graduated pedestrian lighting and transportation services, including electrical cars, shuttle, waiting areas/information booth, GPS positioning, and public parking telemanagement.

Private and domestic services may include secured access, secured collective areas, video concierge, parking video surveillance, anti-intrusion detector, emergency box, domotic box, teledistribution/multimedia information, building technical telemanagement, private areas maintenance, cleaning collective areas and building management.

The entities 108 that provide the various services 104 to the consumers/customers 102 are connected via a framework 106, and linked together. Often times, when one particular service is added to an environment, it may detract from another. For example, the addition of a bus stop or train station may detract from the green space management associated with that environment, and various forms of transportation methods may detract from the air quality, etc. The Systems And Methods For Land-Use Development, Planning And Management addresses and optimizes the relationship between all factors and/or services that may affect people living in that environment. The framework 106 of the Systems and Methods For Land-Use Development, Planning and Management derives a proposed model for optimal allocation of services for consumers/customers 102. The model of services can then be altered and optimized throughout the conception, implementation and maintenance of the land-use plan/model in an iterative process.

A feedback loop 110 is also used so that customer satisfaction may be incorporated into the dynamic optimization process. The data that is provided in the feedback loop may be raw data that is collected from actual residents, and/or other entities, user input from the planner, or the data may be from the results of a model or simulation that is created. The feedback data may then be collected and stored in a database as described in the following figures and associated description. Thus, in one aspect, the Systems and Methods For Land-Use Development, Planning and Management is an optimization process for optimizing the allocation of services to improve quality of life in a land-use plan.

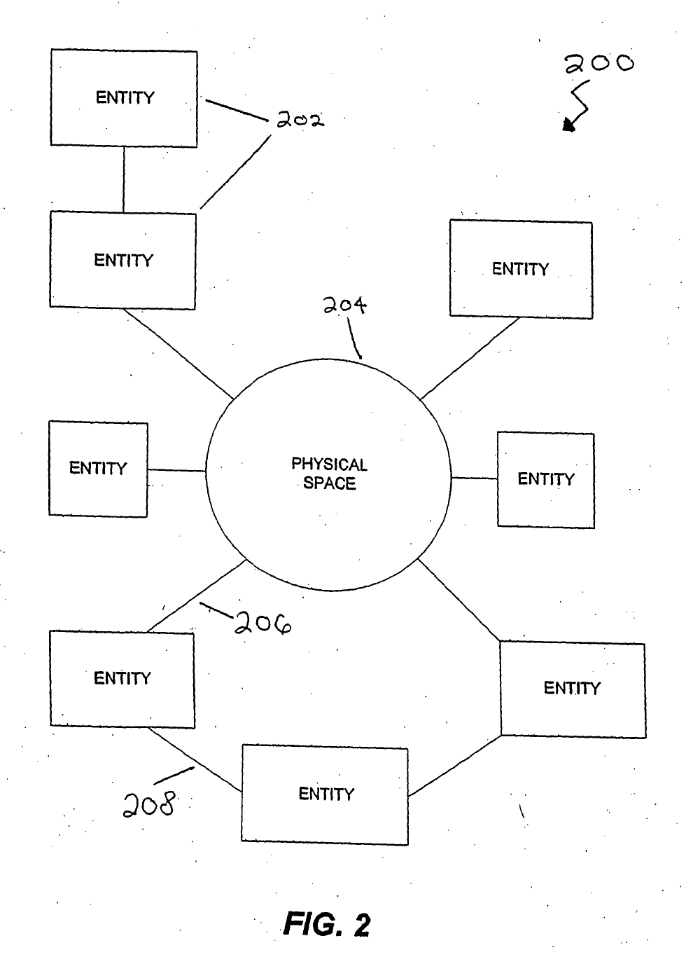

With reference now to FIG. 2 of the drawings there is illustrated therein another embodiment of the network of entities that provide and/or receive services 104, generally designated by the reference numeral 200. The network 200 is comprised of various entities 202 that relate to a physical space 204. As noted above, physical space 204 may be an environment of various magnitudes, e.g., a small neighborhood, a town, or a large metropolitan area. The entities 202 all share and are linked to the physical space 204. As seen by the figure, an entity does not necessarily have to have a physical presence in physical space 204 to impact it. The relationship between the services 104 that are given and received by the various entities 202 impact the quality of life for the people that reside in the physical space 204.

The framework 106 that links entities 202, has a relationship with physical space 204. The framework 106 provides services to customers, where the customers are associated with or reside in physical space 204. As discussed in FIG. 1, the framework 106 utilizes a customer satisfaction component or a feedback loop 110. The framework 106 is used to optimize customer satisfaction and/or quality of life, and to assist in offering services to customers. The framework 106 may evolve in time and/or space, and be flexible, dynamic and/or interactive.

In one embodiment, the systems and methods are a framework 106 or infrastructure to link private infrastructure, public infrastructure and/or their surrounding environs. As seen in FIG. 2, the framework 106 comprises a list of links. The links identify or link two or more entities, or link an entity with the physical space. The links may be direct or indirect links. For example, link 208 directly links an entity 202 to the physical space 204, but link 208 indirectly links entity 202 to physical space 204. The links may be stored in a database, a relational database, or hyperlink storage as hyperlinks. The links may be two-way and comprise text and/or symbols. As discussed in more detail in the remaining figures and detailed description, the framework 106 manages the links, the management may be conducted centrally or de-centrally.

The physical and organizational infrastructure of the private or public entities, preferable includes buildings, equipment and other physical items as well as organizational structure, software data, information, intellectual assets, and other intangibles. Preferably these entities have a relationship including but not limited to a geographical, political environmental, or business relationship. The physical space 204 may be land, sea, outer space, underwater, neighborhood, developed site, and/or an undeveloped site.

The framework 106 comprises a list of services that may be stored in a relational or other database. The services may be categorized. The services may comprise development, environment, security, information and communication, education, health care, cultural life and sport, and transportation services and may be characterized as human, economic, and/or environmental.

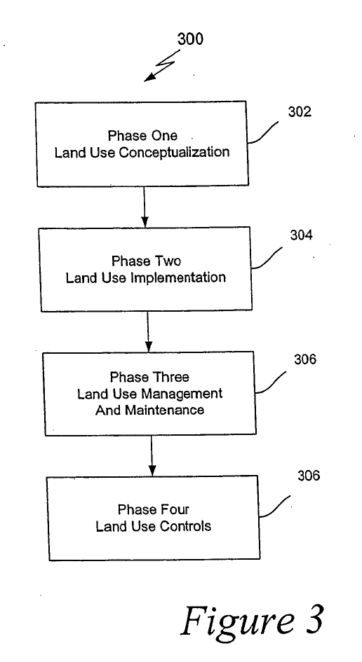

The Systems and Methods For Land-Use Development, Planning and Management is used during four phases of land-use: conceptualization, implementation, management and maintenance, and controls (FIG. 3). In one embodiment the Systems and Methods For Land-Use Development, Planning and Management is implemented in a suite or framework 106 of software comprising six interactive yet independent software routines. While the software suites may be used in a sequential manner, they may also be used in an interactive and/or independent manner. Appropriate computer hardware can be used to run the Systems and Methods For Land-Use Development, Planning and Management software package and store the data. For example, the software may run on a PC, or other computer, and can be stored in a memory device, or other computer readable medium.

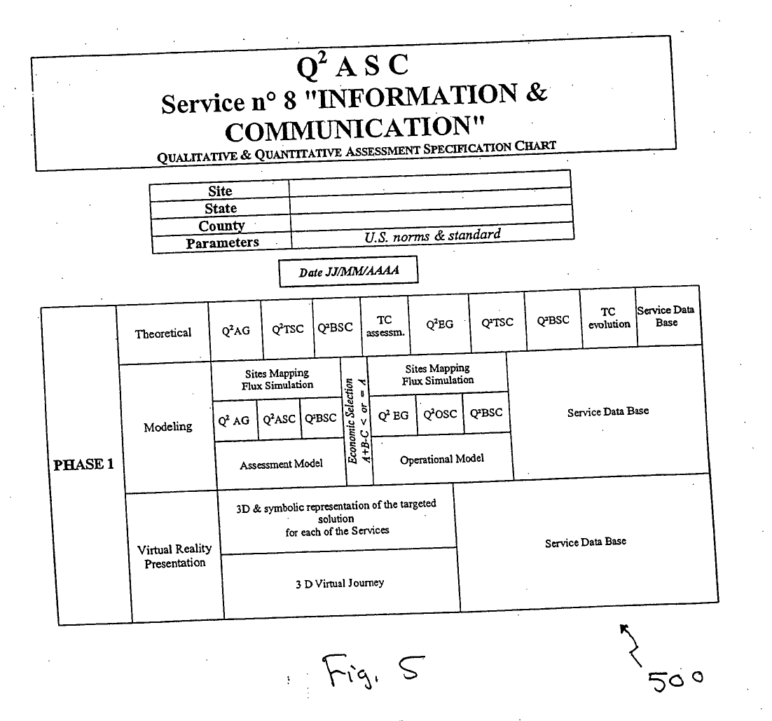

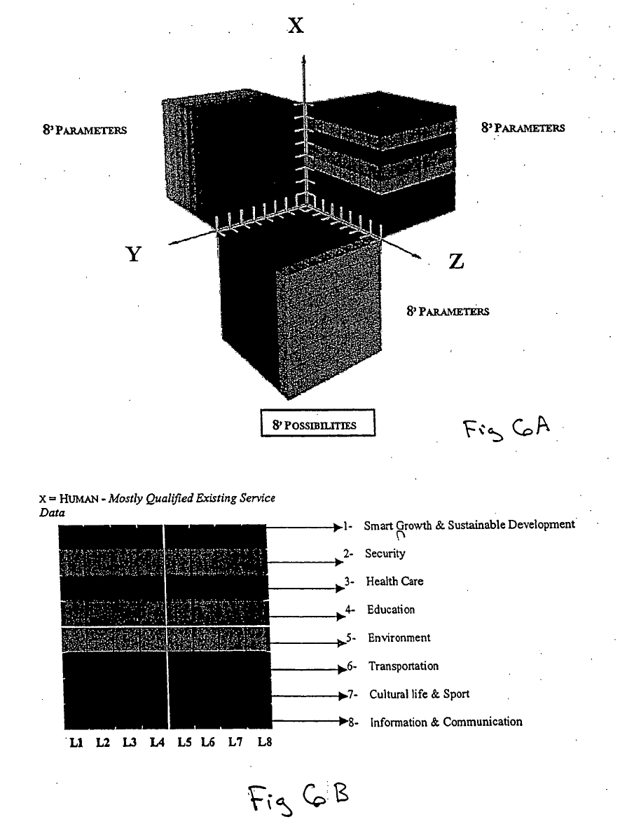

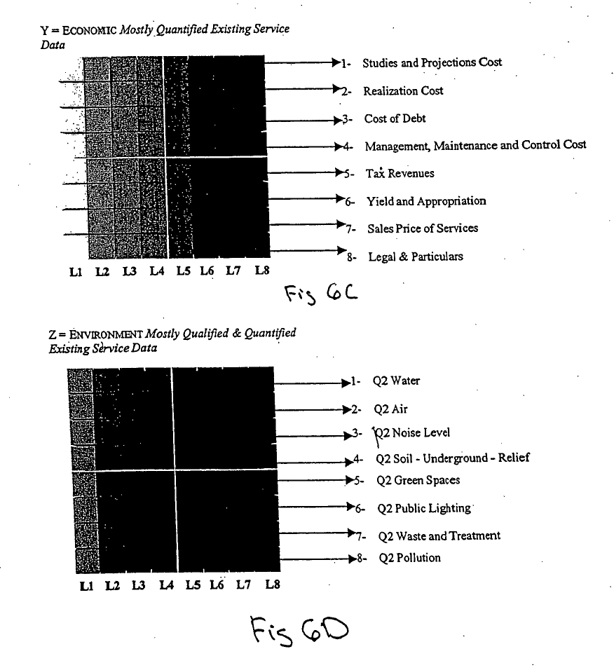

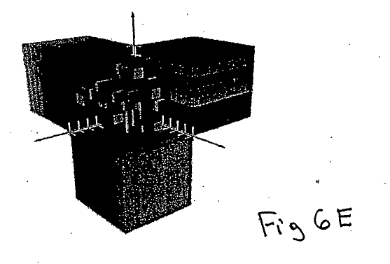

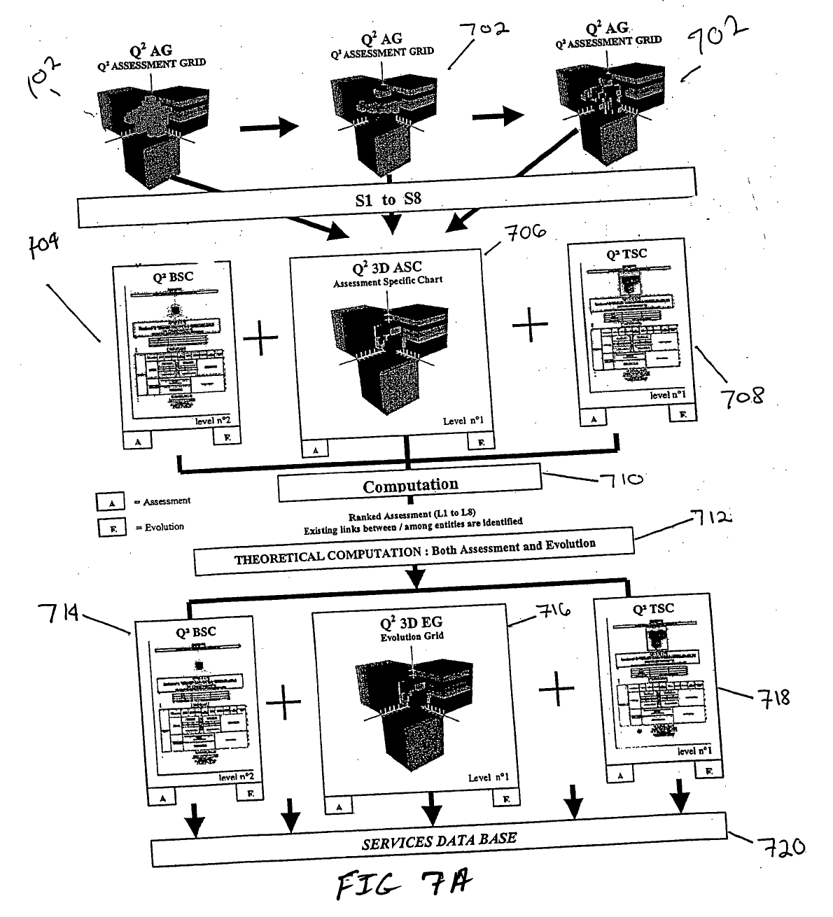

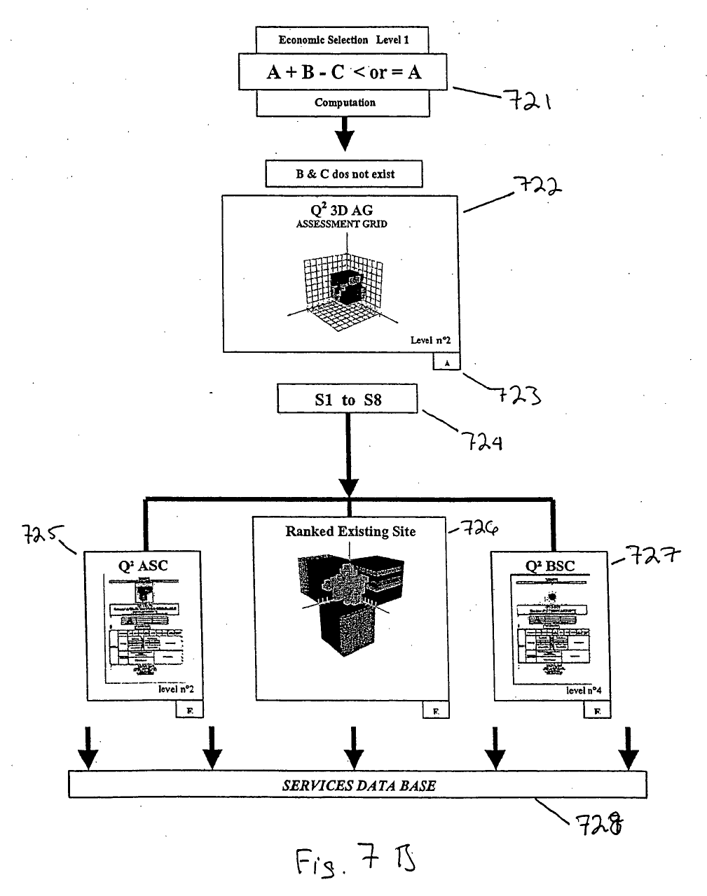

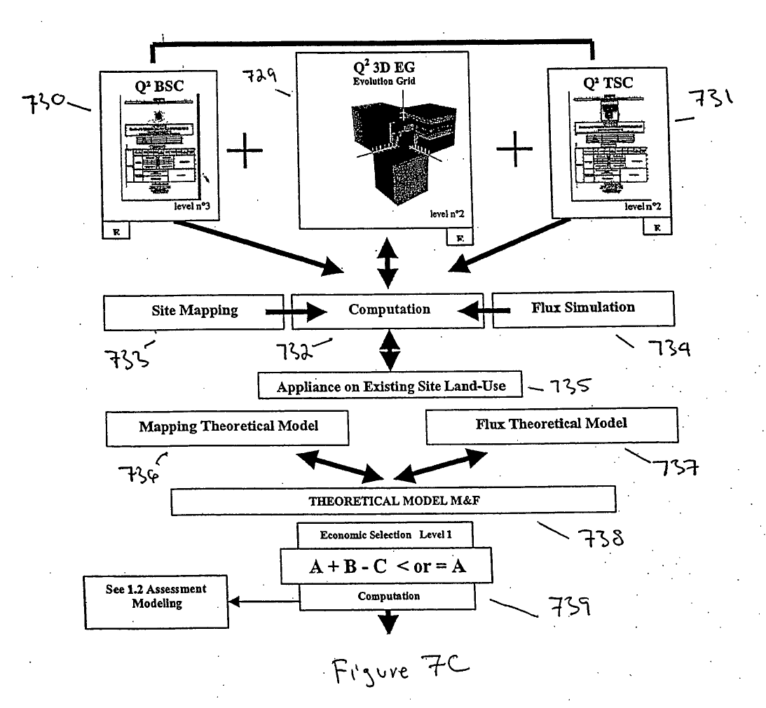

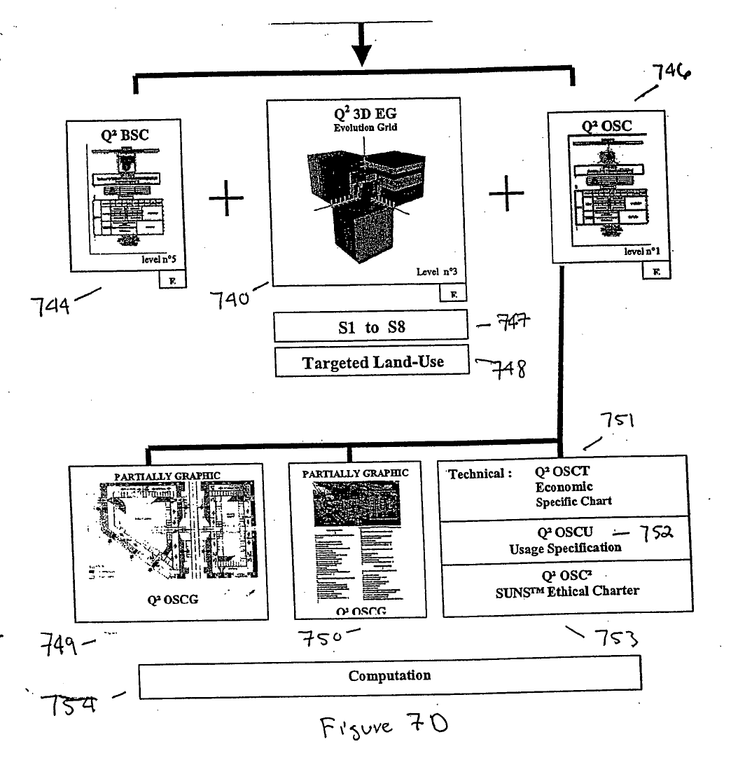

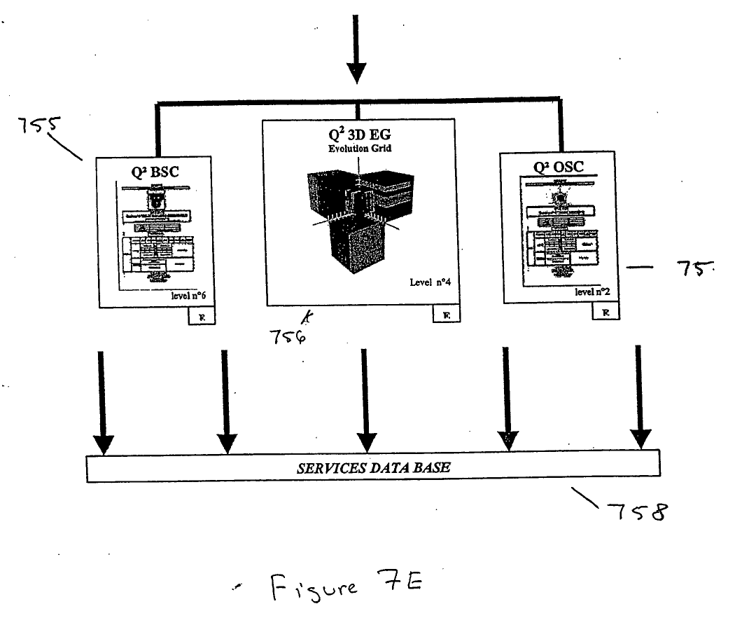

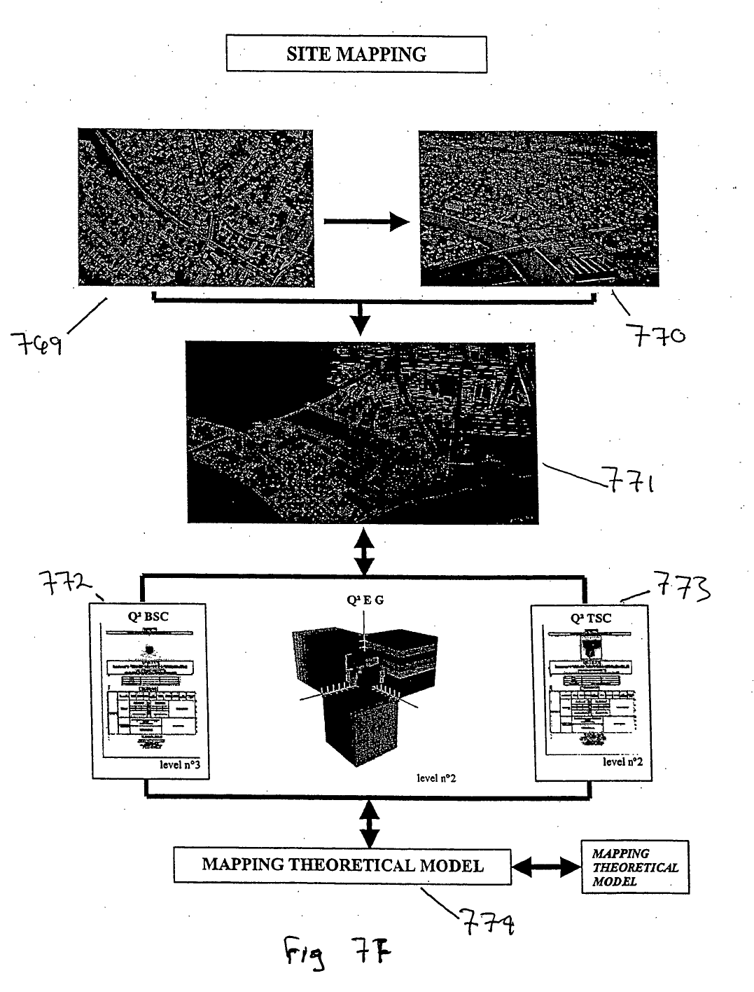

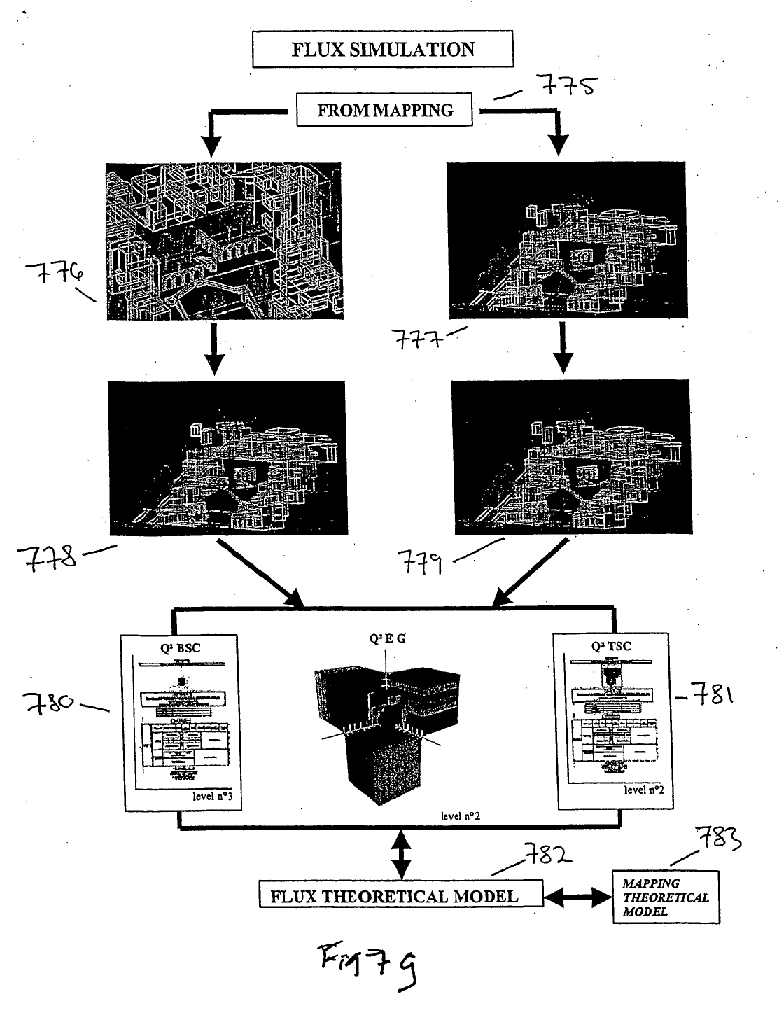

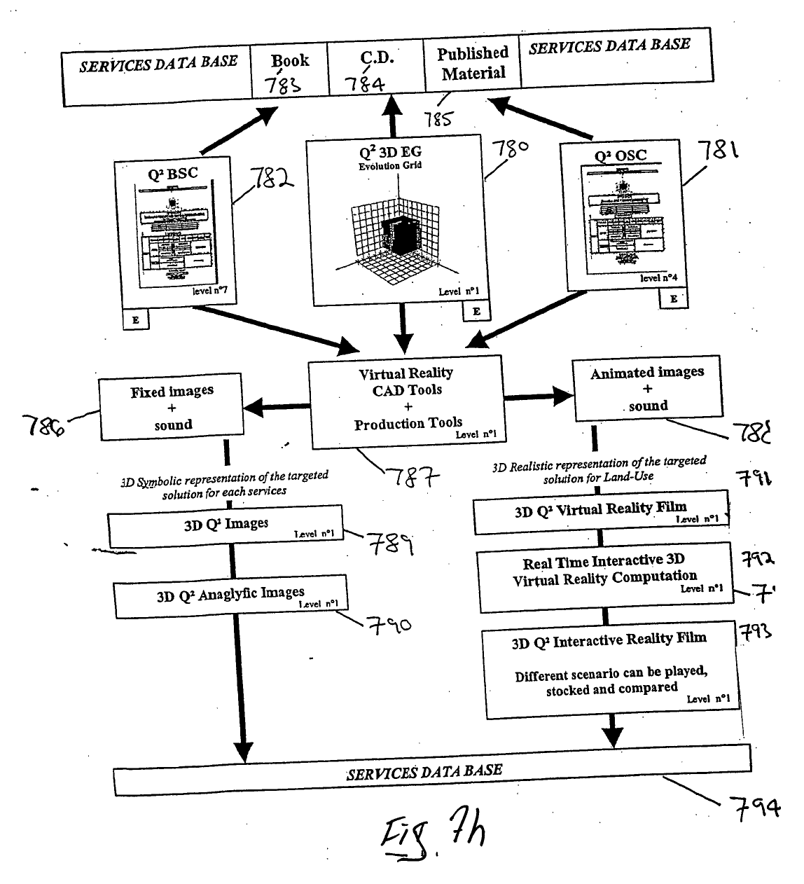

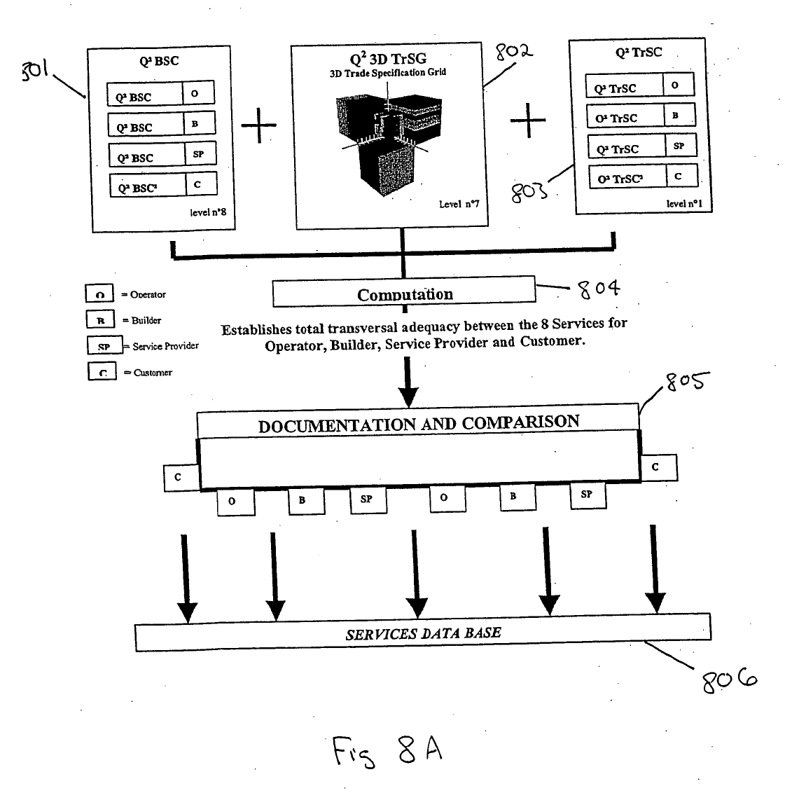

In one embodiment, the software instructions may create and use a theoretical specification chart (FIG. 5). A model may be used to compare the theoretical specification to the present land use. The model highlights incompatible propositions with numeric imaging. A simulation may be based on the model. An operational specification chart, graphical representation, 3d presentation, virtual reality presentation may be created and used. (FIGS. 6A-6E and 7A-H). A three dimensional grid may be used for assessment of the services. Preferably, the three axes represent x=human, y=economic, z=environmental.

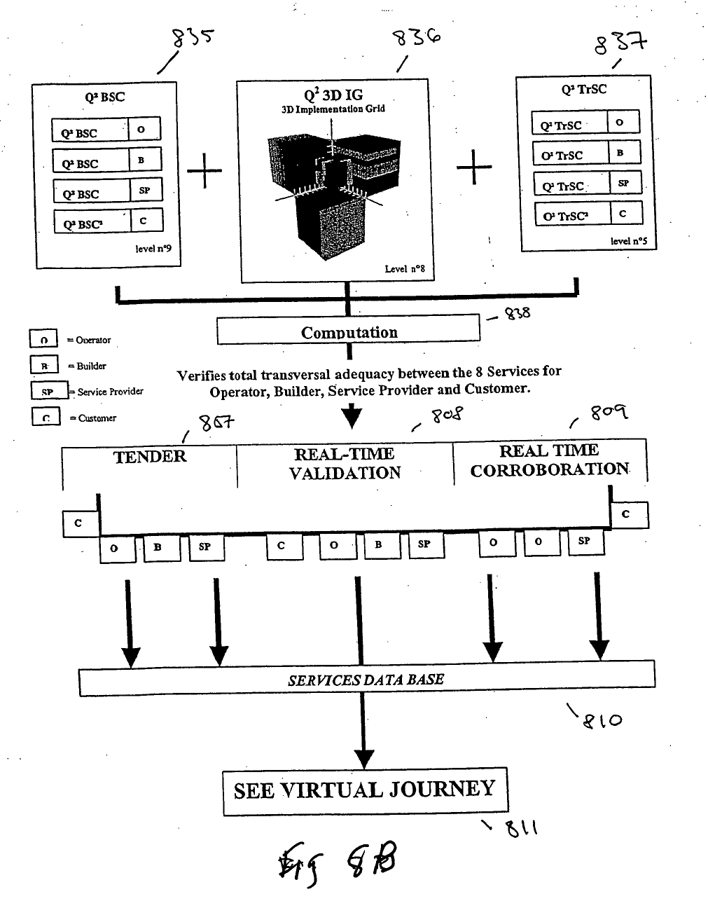

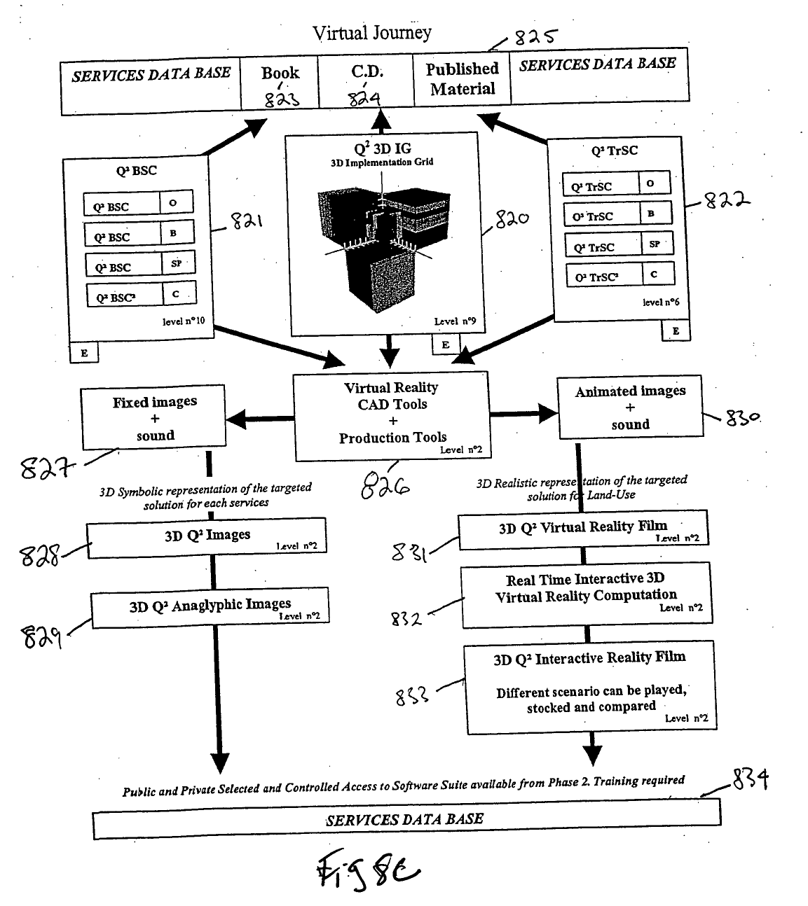

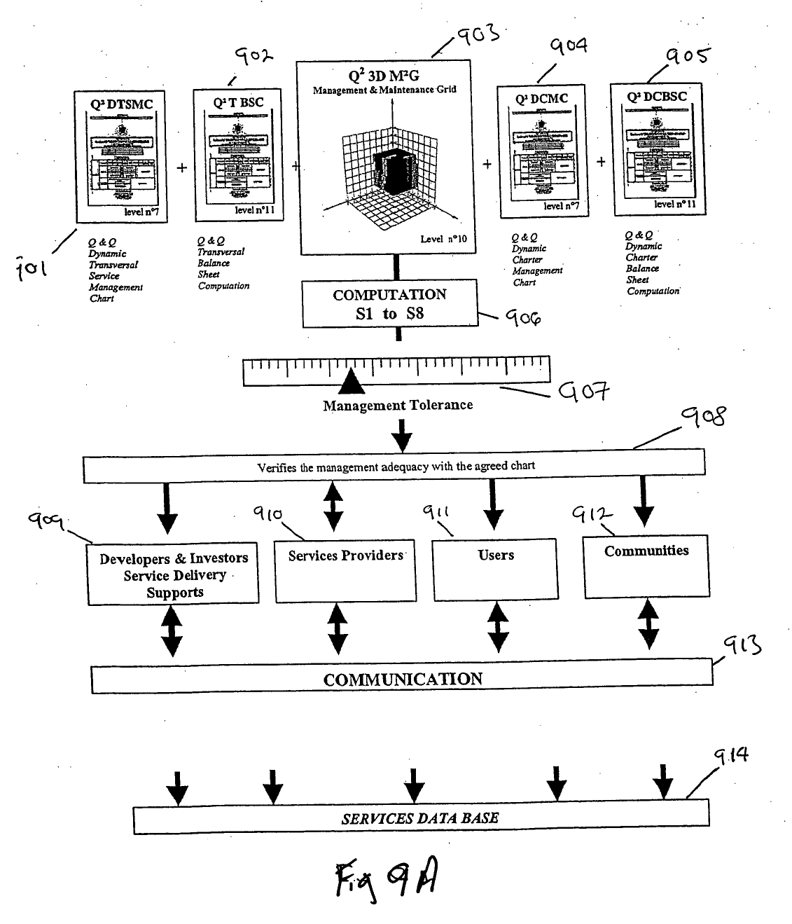

The equation A+B−C< or =A may be used for economic evaluation wherein A represents: the cost of existing services, B represents: the increased cost due to improving the service or services, and C is dependant of the persons or entities concerned with: C1—economy of scale realized when the serve is implemented, C2—economy due to ‘intelligence’ in maintenance and operation of the service, C3—qualitative increase in level and number of services, C4—economic fall out of these improvement, and C5—assurance for the operator to have a rapid return on the investment. (FIGS. 7A-H). In addition, the software or framework 106 may be used in every phase of land-use (FIGS. 7A-H, FIGS. 8A-8C, FIGS. 9A-9D, and FIGS. 10A-10B) to optimize the land-use plan for that particular phase.

### II. PHASES

With reference now to FIG. 3 of the drawings, there is illustrated therein the various phases of land development, generally designated by the reference numeral 300. The phases of land development includes four phases: Phase I 302 is the land use conceptualization phase; Phase II 304 is the land use implementation phase; Phase III 306 is the land use management and maintenance phase; and Phase IV 308 is the land use controls phase.

During the span of development of a particular piece of land or urban area, the development goes through various phases. First, a plan is developed and conceptualized to determine the use for the land. For example, the land may be used for residential use or the land may be used for a business purpose. In addition, the land may also be used for a combination of the two. In the making of these decisions during the conceptualization phase, many factors must be considered. Such factors can include factors that impact human life, environmental life and economic factors. The factors may also have interrelations upon one another. For example, environmental factors can have a direct impact on quality of life for humans living in the affected area. In addition, economic factors may also play a role in future planning of land use and development.

After the conceptualization phase, the plan is implemented in Phase II 304. Implementation of a land use plan impacts many different people and entities in different ways. Examples of such entities may be builders, service providers and/or corporations and residential residents. Often times during an implementation phase it has been found that a planned use must be modified. Therefore, it is important to have a means to determine the impact that certain changes may have upon a planned land use conceptualization.

Once a land use plan is implemented or built in Phase II, the plan is managed or maintained in Phase III 306. During the management and maintenance of a land use plan, needs for services will change over time. For example, a certain environment may become more dependent upon business development and less dependent upon residential use. Changes in the demography of certain environments require changes in services that are provided. Examples of changes may include air quality, transportation needs, lighting, accessibility to food, etc. Therefore, it is important that there exist a means to analyze the changes in services that are needed by the people who reside, live and/or work in certain areas that cover a land use plan.

The fourth phase of land use development is designated by the reference numeral 308 and is called land use controls. During this phase the operators and controllers of the plan monitor the use of the land, the effectiveness of the services provided, and the quality of life of the people who live in the environment impacted by the land use development plan. The operators can monitor, correct, verify conformity and receive responsive feedback from customers or consumers or inhabitants and/or people who live in the impacted area. During Phase IV, it is necessary to monitor and correct services that are provided that enhance or detract from one's quality of life. Furthermore, it is important to receive feedback from inhabitants or customers or consumers in a certain area that is impacted by a land use plan and to integrate systems of correction in monitoring.

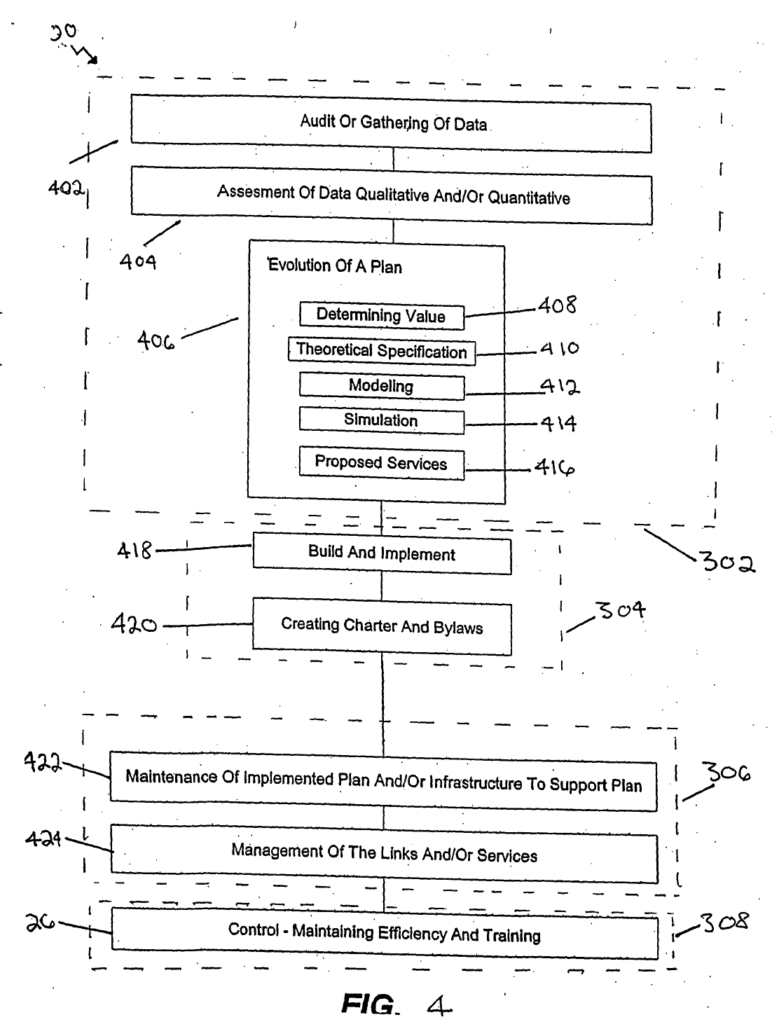

With reference now to FIG. 4 of the drawings, there is illustrated one embodiment or method for land use development planning and management generally designated by the reference numeral 400. The method 400 includes Phase I land use conceptualization 302, Phase II land use implementation 304, Phase III land use management and maintenance 306, Phase IV land use controls 308 from FIG. 3. The method 400 is executed during all of these phases. Phase I, II, III, and IV are designated by the dotted lines and referenced by reference numerals 302, 304, 306 and 308. Phase 1, 302, includes the steps of audit or gathering of data 402 assessment of data qualitative and/or quantitative 404 and the evolution of a plan 406.

The methodology is based on a global, multidisciplinary and transverse approach to land-use and management, for “normal” or “extreme” site development, and utilizes practices and procedures used in architecture, land-use, urban planning and development and their integration with high performance systems in order to deliver services that generate a quality of life based on qualified and quantified parameters.

The auditing or gathering of data 402, may include previous plans, planning documents, strategic plans, data gathered for purposes of creating community planning guides, citizen forums, neighborhood plans, economic development plans, public and private taxes paid by the inhabitants, data on the city's environment and infrastructure, demographic data, data within a geographic information system or the like. The auditing or gathering of data 402 may also include creation of a database such as an ergonomic relational database.

The assessment of data 404, utilizes both a qualitative and quantitative assessment of services. Two (2) dimensional or three (3) dimensional grids may be used for the assessment. The assessment may include the defining of the services into sectors and characterizing of the sectors in 2 or 3 ways to form two or three axes. For example, eight sectors and three axes may be used. The eight sectors may include development, environment, security, information and communication, education, health care, cultural life and sport, transportation. The three axes can be x=human (which is primarily qualitative), y=economic (which is primarily quantitative), z=environmental (which is a combination of qualitative and quantitative). By using the grids the assessed value of present land-use service data may be determined.

The evolution of a plan 406 may be an iterative and interactive process and may include: the determination of value 408 of proposed future land-use services using the same grid as used above to value the current land-use services; the creation of a theoretical specification chart 410 to describe how the future services are combined with infrastructure; the modeling 412 and simulation 414 of future land-use services, where a model may compare a theoretical specification chart with the present land use and highlight incompatible propositions with, for example, numeric imaging; a simulation based on the model that will take into account the consequences of the future land use and offered services based on population flux classified as (1) normal, (2) insufficient, (3) excessive, wherein the model emphasizes incompatible propositions and support decision-making; and/or a proposal 416 of quantified and qualified selection of services, where the services may be selected to meet the objective of reducing the global cost to the investors and the community, and assist with budget planning and control.

Phase II 304 includes the steps of build and implement 418 and creating charter and bylaws for 420. As discussed Systems and Methods For Land-Use Development, Planning and Management may be a dynamic method that may be used throughout all phases of land use. During Phase II of land use, a land use plan is built and implemented. For example, a neighborhood of homes and convenience stores may be built. Build and implement 418 provides an operational specification chart that shows the synthesis of current services and proposed services. In this step, the method may be used to determine in each of the selected sectors, the specifications that are needed beyond and above the usual building trade specifications to successfully implement the transverse dynamic land-use. During this step the method may take into account simulation of possible delivery dates for the equipment and services in each of the sectors for optimum planning. In addition, it is important to create charters and bylaws and other necessary approvals to govern a land use management plan. This is done in step 420.

Phase III 306 includes maintenance of implemented, planned and/or infrastructure to support plan 422 and management of the links and/or services 424. As noted, land use development plans often change and require maintenance and/or management. Certain needs for services may also change. Needs for services may change over time. Also, the various links that link certain services together may change, for example, business relationships and/or certain other environmental factors. Also, as the demography of certain land use areas change, certain links for services may no longer be as strong and/or necessary.

Phase IV 308 includes control/maintaining efficiency and training 426. The last phase of the method includes control systems so that operators can receive feedback and control and change the services and/or other parameters of a land use development plan. During Phase IV 308 a feedback loop of acceptance of technology may be used. Internalizing of the technology by the population is reviewed as well as whether the people need additional education or training.

Throughout all four phases, the use of graphical representational tools are used, including virtual reality presentations. In this manner a virtual journey can be taken through the land-use evolutionary process. Using CAD tools, the representation uses numeric service data of the site and applies 3D symbolic representation of the proposed solution both globally and/or for each of the sectors chosen.

### III. TOOLS

As discussed, the Systems and Methods For Land-Use Development, Planning and Management may be executed in one embodiment with the use of software programs. The software programs may use various tools to aid the optimization processes disclosed herein. In one embodiment, the Systems and Methods For Land-Use Development, Planning and Management utilizes four tools: the specification chart tool, the balance sheet computation tool, the 3-D grid tool, and the virtual journey tool.

With reference now to FIG. 5 of the drawings, there is illustrated therein an exemplary classification chart tool generally designated by the reference 500. Following the I.S.O Standards, the information of all the main subdivided data of the services is inputed into charts. Each chart provides analysis of the 8 proposed services quantitatively and qualitatively. Highlights for each service and the type and percent of the three categories (C1, C2, C3) may be spread then in specific proportional percentage between public and private property. There are different kinds of specification charts for each phase ranked at different levels: L1 to L8.

During the conceptualization phase, Phase I, the charts are populated with data. The populated data may be representative of the current status of the services that are offered in the area impacted by the land use plan. In addition, the chart may contain information that correlates to the level of the quality of service for the various factors. A higher level indicates a better level of service. At the beginning of the implementation phase, a developer may determine an optimum level for the various factors and/or services that are part of the specification chart tool. For example, there may be charts for topics such as smart growth and sustainable development security, health care, education, environment, transportation, culture and sports, information and communication. All of these various themes impact the people that live in the area of the land use development plan. Data that is entered into the chart is used later in Systems and Methods For Land-Use Development, Planning and Management. In addition, the specification chart tool may be populated with data that is representative of proposed levels of service and/or available resources.

In addition to the chart tool, a balance sheet computational tool may also be utilized. The balance sheet computation tool links all the specification charts through an interactive computation. The balance sheet computational tool may be in the form of traditional spreadsheet software. During the development of the implementation phase and planned land use development plan, a developer may populate the data of the balance sheet computational tool with known data of current resources and services. An exemplary balance sheet computational tool that may be used is filed herewith as Appendix A. A balance sheet computational tool may be used to calculate the expenses and revenues or the cost and price of various services and/or resources present in a land use development plan. The balance sheet computational tool can calculate the total amount from the quantities of cost and price per unit. It can also calculate the targeted evolution price based on specific targeted time period or another parameter. The balance sheet computational tool can also calculate the percent of private and/or public services. It can also calculate the category of the service, i.e., C1, C2 or C3, and the percent of each category. The balance sheet computation tool can also rank the quality of the service on an ascending scale, for example, from 1 to 8 with a specific definition for each level.

The balance sheet computational tool can calculate the different existing and/or targeted balances between cost and revenues, different types of services, different types of service categories, and different ranks of service levels. The balance sheet computation tool can calculate the evolution of a service by variation on the quantities, the type, the category and the usage period from beginning to obsolete. All of these calculations can be done for integrated services. The balance sheet computational tool is also used for qualitative and quantitative comparison of each service against one another. Thus, the balance sheet computational tool provides economic insight into the land use development plan. The balance sheet computational tool ties in the actual physical resources present in the area impacted by the land use development plan e.g., physical streets, buildings, parks, etc., into an analytical format. The balance sheet computational tool can provide different levels of calculation give specific numbers, at each step of the description of a service and at each step of a phase from Phase 1 to Phase 4. There is a specific balance sheet computational tool for each of the 8 sectors at different levels (L1 to L8) with different input at Phases I, II, III, and IV.

The third tool utilized by the systems and methods for land use development planning and management software are the assessment and evolution 3D grids. The existing and/or targeted services of each analyzed service feeds the 3D Grids. The 3D grids, through a specific computation optimizes links between the 8 sectors of services and enhances qualitatively and quantitatively all the services at different chosen levels.

With reference now to FIG. 6A of the drawings, there is illustrated therein a qualitative and quantitative three dimensional assessment grid. The grid defines the assessed values of the present land use service data within the eight sectors interactively chained on a 3D orthonormal land use assessment grid with the X axis representative of human factors, the Y axis representative of economic factors, and the Z axis representative of environmental factors. The grids may be viewed in color or gray scale. The color or shading of the grid may indicate the level of the assessed values.

FIG. 6B shows the mostly qualified existing service data that is part of the X axis: row 1 is smart growth and sustainable development, row 2 represents security, row 3 represents health care, row 4 represents education, row 5 represents environment, row 6 represents transportation, row 7 represents cultural life and sport, and row 8 represents information and communication.

FIG. 6C shows the mostly quantified existing service data for the economic data that is part of the Y axis: row 1 is representative of studies and projections costs, row 2 represents the realization cost, row 3 represents the cost of debt, row 4 represents the management, maintenance and control costs, row 5 represents the tax revenues, row 6 represents the yield and appropriation, row 7 represents the sales price of services, and row 8 represents legal and particulars.

FIG. 6D shows the mostly qualified and quantified existing service data for the environmental data that is part of the Z axis: row 1 represents water, row 2 represents air, row 3 represents noise level, row 4 represents soil—underground—relief, row 5 represents green spaces, row 6 represents public lighting, row 7 represents waste and treatment, and Row 8 represents pollution.

With reference now to FIG. 6E, there is illustrated a visualization of combined human and economic assessment parameters. FIG. 6E visually represents to the user both the current human and economic factors. The user of the system can ascertain from FIG. 6E the current assessment of the human factors and the impact on the economic factors, and visa versa. That is, the user can ascertain how the economic factors are impacting the human factors.

In addition, Systems and Methods For Land-Use Development, Planning and Management also utilizes an evolution 3D grid. The evolution grid is not representative of the current assessment of the various parameters that impact the land use development plan, but is representative of planned or desired factors that may impact the land use development plan. For instance, a developer may desire a higher quality of water. However, the higher quality of water may come at a large economic expense. Thus, the developer may visually represent such impact to observers of the evolution grid. Different scenari from the evolution grid can be presented to the customer. The evolution grid, like the assessment grid is a three dimensional grid with X, Y and Z axis that have the same parameters for the X, Y and Z axis of the assessment grid so that a comparison between the assessment grid and evolution grid can be made. Thus, the comparison between the two grids can tell an observer what areas are weak, and it can also tell an observer the impact on other areas that a change may have. For example, a change in a transportation structure may or may not have negative impact on an environmental factor and may have a dramatic impact on human factors. These impacts are readily ascertainable from the visual representations of the grids.

In addition to the previous three tools, the software or framework 106 may use a fourth tool called the virtual journey tool. The virtual journey tool provides a different scenario from the 3D evolution grids and can be presented to a customer. The virtual journey tool can be used for either a sharper study or for a presentation, the software may deliver at each step virtual reality land-use images. Two kinds of images (i) fixed+sound and (ii) animated+sound can be delivered for: book illustration, CDs, published materials, databases and/or 3D fixed images, 3D anaglyphic images, 3D Virtual Reality films, and/or 3D interactive virtual reality films. Virtual reality journey tool, like the other tools, may be used during any phase of the land use development.

### IV. Application of Tools

The Systems and Methods For Land-Use Development, Planning and Management uses the framework 106 via software tools throughout all four phases of land use: (conceptualization, implementation, management and maintenance, and control) to create a optimal land-use plan (FIGS. 6A-6E, FIGS. 7A-H, FIGS. 8A-8C, FIGS. 9A-9D, and FIGS. 10A-10B). Systems and Methods For Land-Use Development, Planning and Management breaks Phase 1 into three different portions: a theoretical portion, a modeling portion and a virtual reality presentation.

FIG. 7A illustrates the theoretical portion where a system that allows for the modeling of the present state of land-use and the objectives, alternatives and choices retained for future land-use is provided. The theoretical portion of Phase 1 begins with the combination of the data from the assessment grids 702 with data from the qualitative and quantitative balance sheet computation 704, the quantitative and qualitative assessment specific chart 706 and the qualitative and quantitative theoretical specification chart 708. As discussed, the quantitative and qualitative assessment grids define the assessed values of the present land-use service-data within the eight sectors interactively chained on the 3D orthonormal land-use assessment grid, where x=human mostly qualified existing service-data; y=economic mostly quantified existing service-data; and z=environmental qualified and quantified existing service-data. The quantitative and qualitative assessment grids allow an alphanumeric, as well as 3D graphic representation, as well as a specific classification of the characteristics of the present land-use. Dedicated values on each axis allow the combinatorial calculation to characterize precisely each site. The assessment grid can therefore be used alone for audit purposes.

A computation 710 is performed and the assessments of the various parameters are ranked, and the existing links between and among the various entities are identified. At step 712, a theoretical computation, both of assessment and evolution is performed. The theoretical computation 712 uses the ranked parameters and existing links from computation 710 to determine the quantitative and qualitative theoretical values of the public and private equipments to be completed by: integrating in the combinatorial calculation the human, economic and environmental bonuses targeted. The theoretical computation 710 uses the existing links and services and the desired level of services to produce a resultant outcome of the effects of the implementation of the desired services. The theoretical computation 710 may be performed for experimental purposes with various data and values of services to query an optimal model. The theoretical computation 710 uses these various forms of data, e.g., services, links, entities, etc. to produce the predicted outcome of various permutations of the various inputs. Resulting from the number of the population that will use these equipments, is the range of services offered and/or the implantation of additional (supplementary) population growth, whose profile will be determined by computation to reach the objectives. This constitutes the assessment specification chart and the evolution specification chart.

The quantitative and qualitative evolution grid 716 calculates the quantitative and qualitative level of services proposed and their objectives in the eight sectors within the targeted scale of values on a 3D orthonormal land-use evolution grid, with dedicated scales of values, which allow a precise characterization of the site with the proposed services, once the combinatorial calculation has been done. This can be done: either from the starting point of fixed objectives, where the parameters in x, y and z are classified and services are deducted, or from the starting point of a series of proposed services, qualified and quantified based on a chosen land-use which classification will be automatically deducted from the result of the computation.

The qualitative and quantitative balance sheet computation 714, the qualitative and quantitative evolution grid 716, and the qualitative and quantitative theoretical specification chart 718 are then organized through a services database, open to the client. The database increases constantly and is renewed in real time 720. The existing services and the new ones will be searchable through the ergonomic service database 720. The Q² balance sheet computation 714 calculates the quantitative and qualitative level of services proposed, and their objectives, in the eight sectors within the targeted scale of values on a 3D orthonormal land-use evolution grid with level, category, public, and private components of each service proposed and their objective in the 8 sectors. The computation of the components is integrated to the assessment and/or evolution grid. Each component can be subdivided as much as necessary. From these calculations the software deducts dynamic specifications, which define and describe the way of combining the services and the smart infrastructures. This constitutes the theoretical specification chart 718 for both the assessment and the evolution grid. This high level optimization of the “smart infrastructure centrally or de-centrally managed” allows the best possible theoretical implementation of data transmission to promote the objectives.

With reference now to FIG. 7B there is illustrated therein the assessment modeling portion of Phase 1. The assessment modeling begins at step 721 economic selection Level 1, where the equation of A+B−C</=A is computated and B and C do not exist. B and C do not exist because this is only the assessment phase. The Economic Selection verifies the economic equation of A+B−C</= to A. The 8 sectors are treated independently; where “A” is the cost of existing services; “B” is the increased cost due to “intelligence added to equipment” to improve the service; and “C” is dependent of the persons or entities concerned with:

C1—Economy of scale realized when the service is implemented.

C2—Economy due to ‘intelligence’ in maintenance and operation of the service.

C3—Qualitative increase in level and number of services.

C4—Economic fall out of these improvement

C5—The assurance for the operator to have a rapid return on the investment.

The objective of the“-C” term of the equation, is to make sure that the global cost to the investor is less than usual by including as many service providers as possible. If there is inadequacy, or if inadequacy is a goal, B and C parameters can be modified to simulate different outcomes. This can be achieved with alpha-numeric data. Virtual reality tools can also be used to visualize the consequences of these simulations. The economic selection 721 generates the ranked existing site 726, the qualitative and quantitative assessment specification chart 725, and the qualitative and quantitative balance sheet computation 727. The services then are organized through a services database, open to the client. The database increases constantly and is renewed in real time 728.

With reference to FIG. 7C there is illustrated therein the modeling portion of Phase 1. The qualitative and quantitative evolution grid 729 and qualitative, quantitative balance sheet computation 730, and qualitative and quantitative theoretical specification chart 731 are used in a computation 732 along with a site mapping 733 and flux simulation 734, and are applied to an existing site 735. Site mapping 733 compares with numeric imaging the theoretical specification chart 731 to the site's present land-use and highlights incompatible data. The flux simulation 734 emphasizes incompatible data and supports decision making through the simulation of corrective actions. The new data can be verified and validated on the quantitative and qualitative evolution grid 729 interactively to come closer to or farther from the theoretical model through a process of eventual disengagement. The software takes into account the consequences of the retained services in different population flux, where 1 is normal; 2 is insufficient; and 3 is excessive. The flux parameters are either implemented incrementally or follow a pre-established procedure. The different options may be highlighted alpha-numerically on the theoretical model.

Mapping theoretical model 736 and a flux theoretical model 737 are used in conjunction to produce a theoretical model of mapping and flux 738. Next, economic selection step 739 performs a computation and produces the qualitative and quantitative evolution grid 740 (FIG. 7D). The qualitative and quantitative balance sheet computation 744, qualitative and quantitative evolution grid 745 and qualitative and quantitative operational specification chart 746 are used in conjunction with the sectors 747 and targeted land use 748 to produce graphic charts 749 and 750. In addition, technical information is provided in a qualitative and quantitative economic specification chart 751, a qualitative and quantitative usage specification 752, and a qualitative and quantitative ethical charter 753. The operational specification chart, which is an alphanumeric and partially graphic, is the synthesis of the selected services. This synthesis takes into account the simulation of the possible delivery dates for the equipment and services in the eight sectors for optimum planning. The synthesis determines in each of the eight sectors the particular specifications that are necessary, beyond and above the usual building trade specifications, to successfully implement the transverse dynamic of the projected land-use. Derived from the optimal combinatorial calculation of all the parameters, the synthesis determines the specifications in each of the eight sectors of the services to be rendered and their implementation on the site. The operational specification chart 746 includes the technical-economic specification chart 751, the usage specification chart 752 and the ethical charter 753. A computation is performed at step 754 and the qualitative and quantitative balance sheet computation 755, (FIG. 7E) qualitative and quantitative 3D evolution grid 756, and qualitative and quantitative operational specification chart 757 are organized through a services database, open to the client. The database increases constantly and is renewed in real time 728.

FIG. 7F provides an illustration of the site mapping 733. Site mapping 733 compares with numeric imaging the theoretical specification chart to the site's present land-use and highlights incompatible data. Images 769 and 770 are transformed into a transformed image 771. The qualitative and quantitative balance sheet computation 772 is used in conjunction with the qualitative and quantitative theoretical specification chart 773 to produce a mapping of the theoretical model 774.

FIG. 7G illustrates the flux simulation used by the modeling that occurs in Phase 1. Flux simulation emphasizes incompatible data and supports decision making through the simulation of corrective actions. The new data can be verified and validated on the 3D Quantitative and Qualitative Evolution Grid interactively to come closer to or farther from the theoretical model through a process of eventual disengagement. Images 776, 777, 778 and 779 are used in conjunction with the qualitative and quantitative balance sheet computation 780 and the qualitative and quantitative theoretical specification chart 781 to produce a flux theoretical model which is then used as part of the mapping theoretical model 783.

With reference now to FIG. 7H, there is illustrated therein the third portion of the Systems and Methods for Land Use Development Planning and Management of Phase 1. The third portion is the virtual reality presentation. The virtual reality presentation presents data in a Virtual Reality environment for the client to take a virtual journey through land-use evolution. Based on commercial off the shelf CAD tools the representation takes the numeric service-data component of the site and applies the 3D symbolic representation of the proposed solution, for each of the 8 categories of services. FIG. 7H illustrates that various methods of virtual reality may be utilized to present to the user the results of the computations. For example, the qualitative and quantitative balance sheet computation 782, the qualitative and quantitative evolution grid 780, and the qualitative and quantitative operational specification chart 781 may be presented to a user via a book 783, a CD 784, or other published material 785.

In addition, the qualitative and quantitative balance sheet computation 782, the qualitative and quantitative evolution grid 780 and the qualitative and quantitative operational specification chart 781 may be produced via virtual reality CAD tools plus production tools 787. The CAD and production tools 787 may be of the form of fixed images plus sound 786 where the 3D symbolic representation of the targeted solution for each of the services may be represented with 3D qualitative and quantitative images 789 and 3D qualitative and quantitative anaglyphic images 790. Alternatively, the CAD and production tools 787 may be represented via animated images plus sound 788. The 3D realistic representation of the targeted solution for land use may be used via a 3D qualitative and quantitative virtual reality film 791, and a real time interactive 3D virtual reality computation 792, or a 3D qualitative and quantitative interactive reality film 793. The virtual reality is then organized through a services database, open to the client. The database increases constantly and is renewed in real time 794.

In summary, during Phase 1, there are different levels for each specification chart, ranked from Level 1 to Level 8. Phase 1 uses the following specification charts: the Q² Assessment Specification Chart; the Q² Evolution Specification Chart; the Q² Theoretical Specification Chart; and the Q² Operational Specification Chart. The balance sheet computation tool (“Q².B.S.C”) tool computes: the Theoretical Balance Sheet Computation; the Modeling Balance Sheet Computation; and the Virtual Reality Balance Sheet Computation. There are two Q²3D Grids with a ranked performance level from L1 to L8: the Q² Assessment Grid (Q² A.G.), and the Q² Evolution Grid (Q².E.G.). The Q²3D Grids offer the possibility of multiplying the numeric data, to be computed at an exponential rate 8³-8⁹-8²⁷ . . . 8ⁿ. From the Operational Specification Chart, information treated in Phase 1 is multiplied at the customer's will for all aspects of the implementation Phase 2. Virtual reality images can be provided from the 3D Assessment Grid (existing site) and the 3D Evolution Grid (targeted land-use).

With reference now to FIG. 8A of the drawings, there is illustrated therein a portion of Phase 2 land use implementation where Systems and Methods For Land-Use Development, Planning and Management implement the concepts that were formulated during Phase 1. The first portion of Phase 2 is the operator builder service provider trade specification portion, which is directly issued from the preceding phase and constantly refers to the performance objectives set forth in the evolution grid and the operational specification chart, and the balance sheet computation. This portion refers to the specifications and establishes a total traverse of adequacy between the 8 sectors. The total traverse is done via documentation and comparison. The method uses the balance sheet computation 801, the trade specification grid 802, the theoretical specification chart 803, and a computation 804 to establish transversal adequacy between the 8 services for operators, builders, service providers and customers, thereby providing an optimal and efficient plan and to the aforementioned parties.

Documentation in comparison is generated at 805. The documentation gives written and graphic representation of the services specifications for those involved in the development of the site per operator, builder and service providers trade and ensures coordination of the overall project. The comparison compares the description of the public and private equipments chosen by the different trades to reach the objectives and support the services as set forth in the specification chart. The information is then organized through a services database, open to the client. The database increases constantly and is renewed in real time 806.

With reference now to FIG. 8B, there is illustrated therein a second portion of Phase 2—implementation. The method uses the balance sheet computation 835, and the implementation grid 836, the theoretical specification chart 837, and a computation 838 to verify total transversal adequacy between the 8 services for operators, builders, service providers and customers, to establish tender 807, real-time validation 808 and real-time corroboration 809.

The profile of the operator, builder and service providers is derived from the operational specifications chart. Tender 807 allows the comparison between the offers and the required specifications to classify the best offers. The offers are validated after being successfully tested on the 3D Evolution Grid and must correspond to the classification retained by the client. In case of aberrations the software highlights the result, which affects the equipment and/or service—or the family of equipment and/or services—that does not satisfy the retained classification. Tolerance parameters can then intervene, the results being then defined within a range of acceptability. Real-time validation 808 verifies real-time implementation by: comparing the work progress with scheduling and with the objectives of the public/private equipments; testing their performances at delivery, and by comparing the progress of the implementation of the tools supporting the services offered by public/private service providers by testing their performances at delivery. Real-time corroboration 809 verifies the corroboration of public equipments with private equipments and public services with private services. The information is then organized through a services database, open to the client. The database increases constantly and is renewed in real time 810. The information can then be used for the virtual journey 811.

With reference now to FIG. 8C there is illustrated therein the third portion of the Phase 2 land use implementation. The third portion is the virtual reality presentation. FIG. 8C illustrates how the 3D implementation grid, the balance sheet computation 821 and the trade specification chart 822 may be presented via a virtual journey. For example, the implementation grid 820, balance sheet computation 821, and the trade specification chart 822 may be presented in a book 823, a CD 824 or published material 825. Alternatively, the materials may be presented via virtual reality CAD tools or production tools 826. This may be done via fixed images and sound 827 where 3D symbolic representation of the targeted solution for each services may be portrayed in 3D quantitative and qualitative images 828 and 3D quantitative and qualitative anaglyphic images 829. Instead of fixed images 827, the virtual reality CAD tools and production tools 826 may be produced via animated images and sound 830 where a 3D realistic representation of the targeted solution for land use is produced via a quantitative and qualitative virtual reality film 831, or a real time interactive 3D virtual reality computation 832 or a 3D quantitative and qualitative interactive reality film 833. Different scenarios can be played, stocked and compared. The information is then organized through a services database, open to the client. The database increases constantly and is renewed in real time 834.

In summary, during Phase 2, the following Trade Specification Charts (Tr.S.C.) are used: Operator (Tr.S.C.O.), which provides documentation of Service Data & Service Graphic representation, and comparison with: Operational Specification Chart (O.S.C.), Qualitative and Quantitative Balance Sheet Computation (‘Q².B.S.C); Builder (Tr.S.C.B.), which provides documentation of Service Data & Service Graphic representation, and comparison with: O.S.C. and Q² B.S.C.; Service Provider (Tr.S.C.SP), which provides documentation of Service Data & Service Graphic representation, and comparison with O.S.C., and Q² B.S.C.; Customer (Tr.S.C²), which provides documentation of Service Data & Service Graphic representation, and comparison with: O.S.C. and Q² B.S.C. Phase 2 may utilize the following Implementation Charts (I.C.): Implementation Tender Chart (I.T.C) for Operator (I.T.C.O.), Builder (I.T.C.B.), and Service Provider (I.T.C.SP.); Real Time Validation Chart (R.T.V.C.) for Operator (R.T.V.C.O.), Builder (R.T.V.C.B.), Service Provider (R.T.V.C.SP.), and Client (R.T.V.C².); Real Time Corroboration Chart (R.T.C.²) for Real-Time Public & Private Corroboration Chart Equipment, and Real-Time Public & Private Corroboration Chart Services. In Phase 2 the Q².B.S.C. computes: The Trade Specification Balance Sheet (Tr.S.B.S.) for the Operator, Builder, Service Provider, and Customer; and the Implementation Balance Sheet Computation (I.B.S.C.) for the Implementation Tender Chart, Real Time Validation Chart, and Real Time Corroboration Chart. The 3D Trade Specification Grid (3D Tr.S.G.) establishes total transverse adequacy between the eight sectors for: the Operator (Documentation & Comparison), Builder (Documentation & Comparison), Service Provider (Documentation & Comparison) and Customer. The 3D Implementation Grid (3D.I.G.) establishes total transverse adequacy between the eight sectors for the Operator, Builder, Service Provider and Customer. Technically the 3D Specification and Implementation Grid may use the most important computed data through Real-Time validation by Comparing and Testing the work progress and Comparing and Testing the performance at delivery. Virtual reality images can be provided from the 3D Implementation Grid at different stages of the land-use implementation.

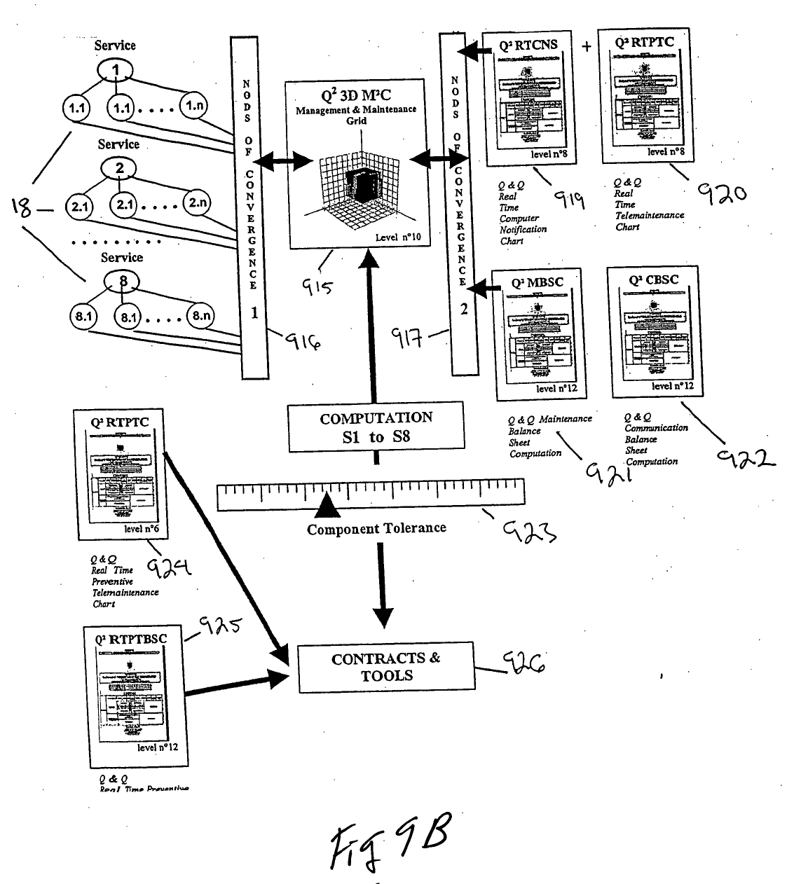

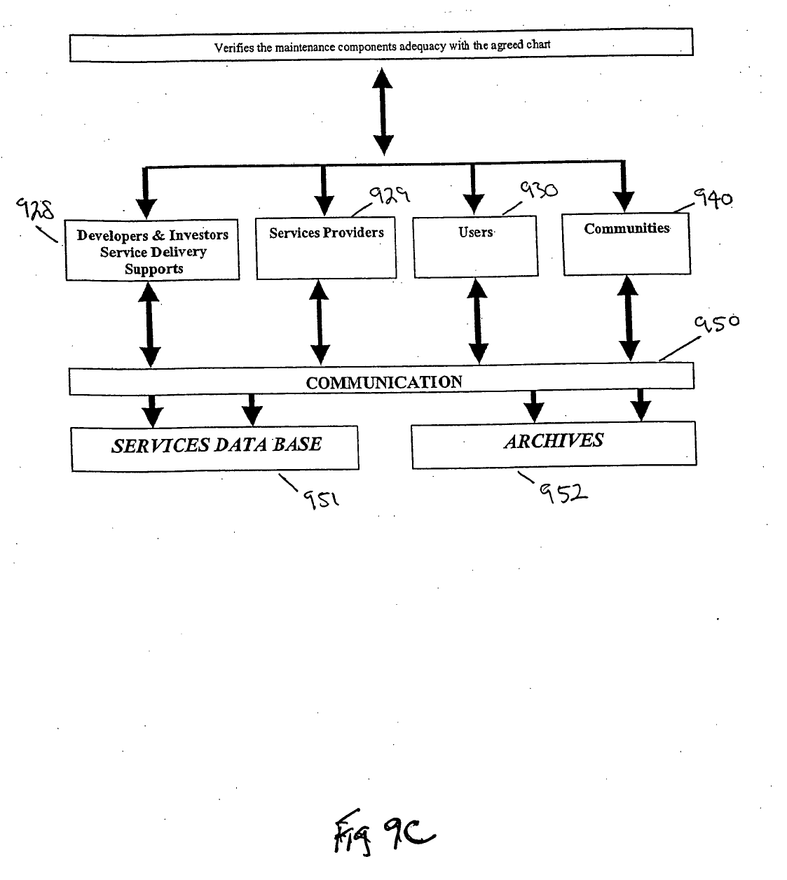

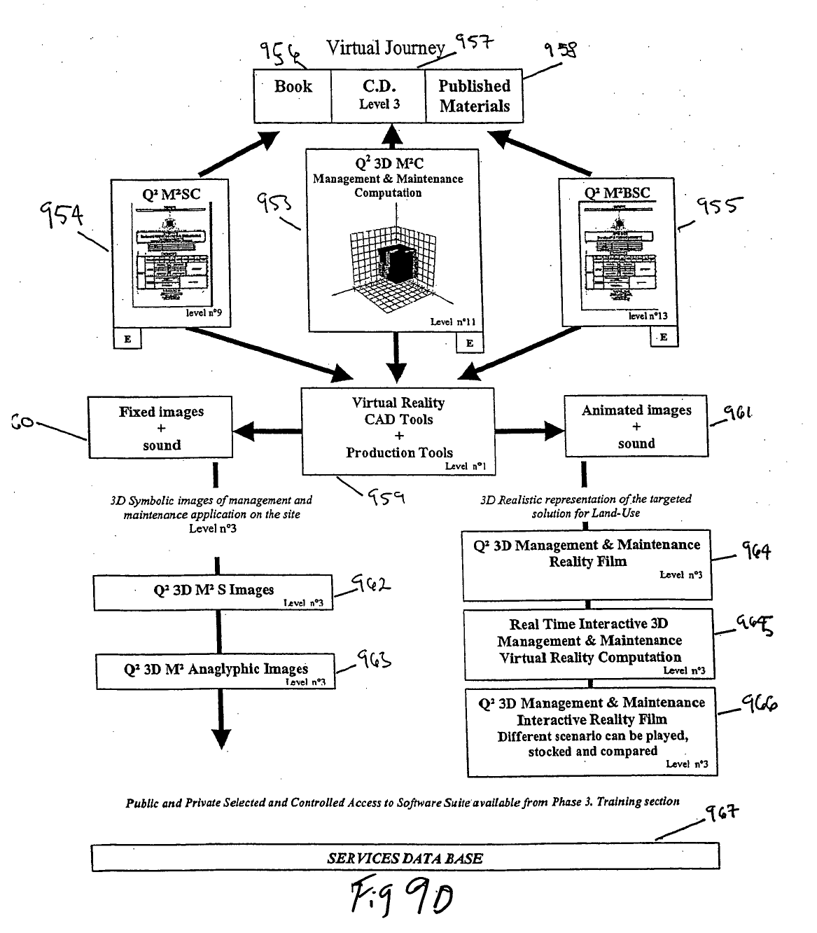

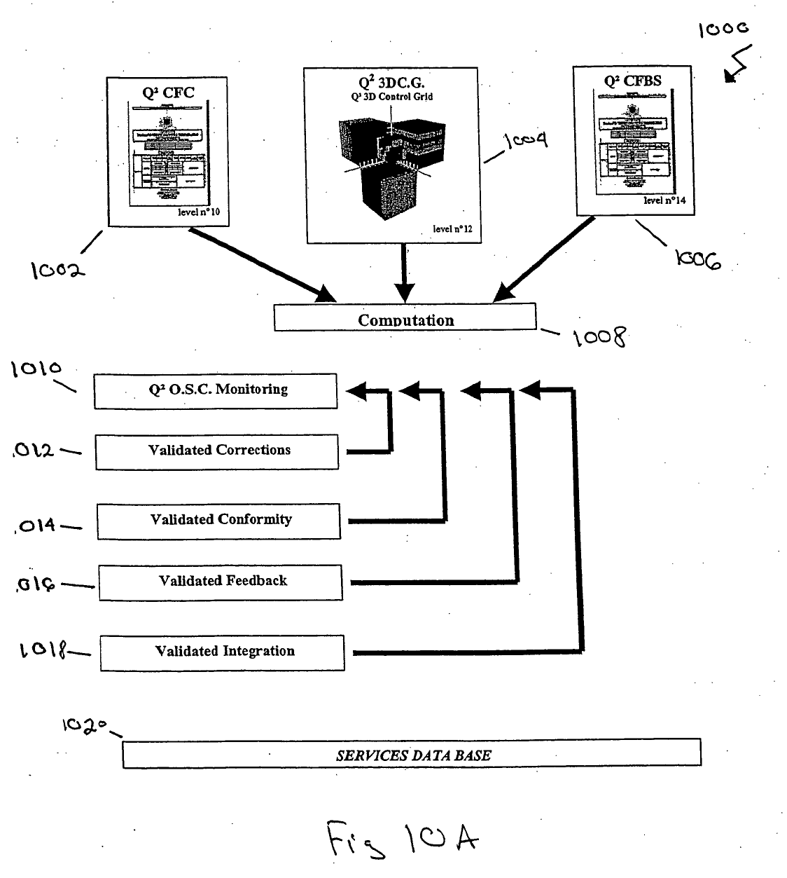

With reference now to FIG. 9A there is illustrated therein the management and communication portion of Phase 3. The dynamic transversal service management chart 901, the transversal balance sheet computation 902, the management and maintenance grid 903, the dynamic charter management chart 904, and the dynamic charter balance sheet computation 905 are used in a computation 906 for the various 8 sectors to compute a management tolerance 907.

The dynamic transversal services management chart is a computerized macro-management beyond and above the daily duties of the operators. The dynamic transversal services management chart 901 assures the application by the retained entities of the transversal aspects of equipments and services in the eight sectors and concerned operators and users. This is done through a specific 2D grid, derived from the 3D evolution grid, and allows the follow up of the process of transversal dynamics of the stated objectives and performances between the eight sectors. It concerns 4 categories of stakeholders: Developers and investors services delivery supports 909, services providers 910, users 911 and communities 912. The dynamic charter management insures the respect of the Technical-Economic Specification Chart, the Usage Specification Chart and the Systems and Methods For Land-Use Development, Planning and Management Charter by the operators and the users. This is performed through a specific 2D grid, derived from the 3D evolution grid to insure the execution of the stated objectives and performances between the eight sectors. It also concerns 4 categories of stakeholders. The management adequacy is verified with the agreed chart with four categories of stake holders 908. This ensures the respect of the technical economical specification chart, the usage specification chart and the charter by the operators and the users.

Communication 913 allows for information management and maintenance and real-time access. Information management and maintenance is used independently and allows the diffusion of information based on the communication protocols of the four categories of stakeholders. Information is managed with protocols for archive and confrontation with the specific Systems and Methods For Land-Use Development, Planning and Management regulations. The software becomes accessible to private and/or public entities by selected and controlled access. The information is then organized through a services database, open to the client. The database increases constantly and is renewed in real time 914.

With reference now to FIGS. 9B and 9C of the drawings, there is illustrated therein the maintenance and communications portions of Phase 3. The maintenance of the overall land use plan is made possible by the management and maintenance grid 915 in communication with the nods of convergence 916 and 917. The nods of convergence 916 monitors the various services designated by the reference number 918. The nods of convergence 917 receives information from the real time computer notification charts 919, the real time telemaintenance chart 920, the maintenance balance sheet computation 921 and the communications balance sheet computation 922. The real-time-computer-notification system is preventive maintenance and consists in a computerized management system done through a specific 2D grid, derived from the 3D evolution grid whose components are connected to the components of the eight sectors. It allows the follow-up of the process of preventive maintenance of the interconnected tools of the stated objectives and performances between the eight sectors. It concerns the 4 categories of stakeholders.

A computation is performed on the various sectors and a component tolerance is calculated 923. The real time preventative telemaintenance chart 924 and real time preventative telemaintenance chart balance sheet computation 925 are used to determine the contract and tools information 926. This information is used in conjunction with the calculated component tolerance to verify the management adequacy of the agreed chart 927 (FIG. 9C). Real-time preventive telemaintenance goes beyond and above the daily duties of the operators. A real-time-computer-notification system alerts the equipment and service providers of the tasks to be accomplished to comply with the responsibilities as defined in the maintenance contracts. The accent is especially made on the nods of convergence of the transversal aspect of the applications of equipment and services. They are the most sensitive and, due to their complexity are those that are responsible for the failures of the system. Solutions are generated incrementally, from alert to by-pass, replacement, or halt of part of the services. The four categories of stake holders, the developers and investors service delivery supports 928, the service providers 929, the users 930 and communities 940, receive the verification 927. Communication is established between all stake holders 950 and the services database 951 and archives 952.

With reference now to FIG. 9D there is illustrated therein the virtual journey of Phase 3. The management and maintenance computation grid 953 is used in conjunction with the management maintenance balance sheet computation 955 and the management and maintenance specification chart 954 to produce a virtual journey. Like the other phases, the information may be virtually presented via a book 956, a CD 957 or published materials 958. Similarly, the information may be presented via virtual reality tools such as CAD tools and/or production tools 959. The virtual reality may be fixed images plus sound 960. The fixed images and sound may be three dimensional management and maintenance S images 962 or three dimensional management and maintenance anaglyphic images 963. Alternatively, the virtual reality tools may be of the medium of animated images and sound 961, and provide a 3D realistic representation of the targeted solution for land use. The animated images and sound may be a reality film 964 or real time interactive 3D virtual reality computation 965, and/or a management and maintenance interactive reality film. The information is then organized through a services database, open to the client. The database increases constantly and is renewed in real time 967.

In summary, during Phase 3, the following specification charts are used: Management Charts (MgC): Q² Dynamic Transversal Service Management Chart (Q².D.T.S..Mg.C), and Q² Dynamic Charter Management Chart (Q².D.C.Mg.C); Maintenance Charts (Mtc): Q² Real Time Preventive Telemaintenance Chart (Q².R.T.P.T.C.), and Q² Real Time Computerized Notification System Chart (Q².R.T.C.N.C.); Communication Charts (C²): Q² Communication Protocols Chart (Q².C.P.C), and Q² Confrontation Protocols Chart (Q².C.P.). The input of Phase 3 uses data from the: Q² Management Balance Sheet Computation (MG.B.S.C); Q² Maintenance Balance Sheet Computation (MTB.S.C); and Q² Communication Balance Sheet Computation (C².B.S.C.). The 3D Q² Management Grid computes data: from the Q² Dynamic Transversal Service Management Chart, and the Q² Dynamic Transversal Balance Sheet Computation Chart; and the Q² Dynamic Charter Management Chart, and Q² Dynamic Charter Balance Sheet Computation Chart, so that present management uses are in adequacy with the agreed upon charts and the present tool components are in adequacy with the agreed charts. The 3D Q² Management Grid also computes data from the Q² Real Time Preventive Telemaintenance Chart, and the Q² Real Time Preventive Telemaintenance Balance Sheet Computation, and Q² Real Time Computerized Notification System Chart, and Q² Real Time Computer Notification Balance Sheet Computation. The 3D Q² Maintenance Grid computes data to verify the maintenance adequacy with the agreed charts and to verify the tool components adequacy with the agreed charts. The 3D Communication Grid sends through a specific interactive software information to the four categories of stakeholders. Virtual reality images can be provided from the 3D Land-Use Management and Maintenance Grid; The Management, Maintenance and/or Communication aspect can be highlighted.

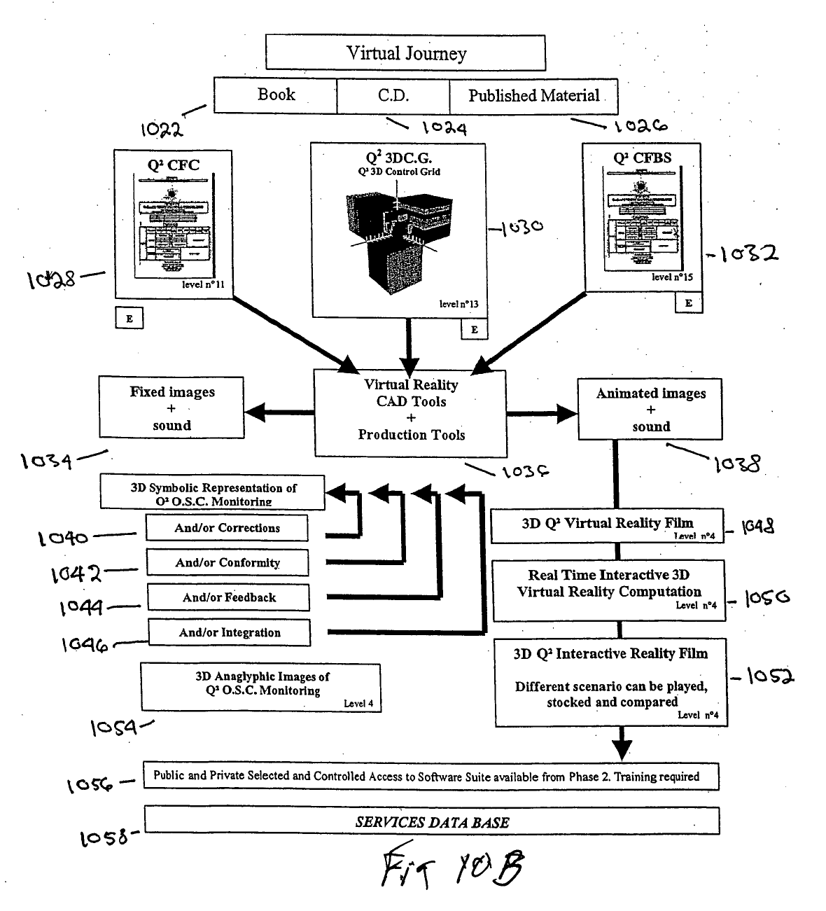

With reference now to FIG. 10A of the drawings there is illustrated therein the land use controls portion of Systems and Methods For Land-Use Development, Planning and Management, generally designated by the reference numeral 1000. The control portion 1000 is accessible to private and/or public entities by selected and controlled access. The control and feedback chart 1002 is used in conjunction with the control grid 1004 and the control and feedback balance computation sheet 1006 and a computation 1008 to control the overall land use development plan. The control portion 1000 is able to monitor 1010, validate corrections 1012, validate conformity 1014, validate feedback 1016, and validate integration 1018.

Monitoring 1010 monitors the respect of the Technical-Economic Specifications-the Usage Specifications and the Systems and Methods For Land-Use Development, Planning and Management Charter by operators and users. This monitoring system is based on a specific 2D grid derived from the 3D evolution grid and compares the stated objectives and performances with the reality. It highlights the dysfunctions with the same methods as above. It concerns the aforementioned 4 categories of stakeholders. Validated Corrections 1012 validates when dysfunctions occur, corrections of errors, and obsolescence or rejection of a service is applied to the model. The procedure causes the reintegration of the corrections from the most upward phases. Validated conformity 1014 validates that the conformity between the corrections and the objectives of the 3D evolution grid is set forth after agreement between the customers and/or communities and the service providers. The procedure causes the reintegration of the corrections from the most upward phases. Validated feedback 1016 validates feedback procedures and allows the reintegration of the corrections from the most upward phases. Validated integration 1018 validates the planning of evolution is modified with the agreement of the customers and/or communities and the service providers. The information is then organized through a services database, open to the client. The database increases constantly and is renewed in real time 1020.

With reference now to FIG. 10B of the drawings there is illustrated therein the virtual journey of Phase 4 of Systems and Methods For Land-Use Development, Planning and Management. The control and feedback chart 1028 is used in conjunction with the control grid 1030 and the control and feedback balance sheet computation 1032 to produce a virtual journey for a user. As with the other phases the virtual journey may be produced via a book 1022, a CD 1024 or published material 1026. The virtual journey also may be produced via virtual reality with CAD tools and production tools 1036. This may be in the form of fixed images and sound 1034 with the 3D symbolic representation of operational specification chart monitoring, with corrections 1040, and/or conformity 1042, and/or feedback 1044, and/or integration 1046; or via anaglyphic images of the operational specification chart monitoring 1054. In addition, the virtual reality CAD and production tools 1036 may be produced via animated images and sound 1038. This may be done via a virtual reality film 1048, a real time interactive 3D virtual reality computation 1050, or an interactive reality film 1052. Different scenarios may be played, stopped and compared. The public and private selected and control access to this offer suite is available from Phase 2 1056. The information is then organized through a services database, open to the client. The database increases constantly and is renewed in real time 1058.

In summary, during Phase 4, the following specification charts are used: Q² Control & Feedback Software Chart: (Q².C.F.C): Q² Monitoring Chart (Q².M.C.); Q² Correction Chart (Q²C²); Q² Conformity Chart (Q²C²); Q² Feedback Chart (Q².F.C.); and Q² Integration Chart (Q² I.C.). The balance sheet tool inputs theoretical data from the Operational Specification Chart (O.S.P.) through the Q² Control and Feedback Balance Sheet Computation (C.F.B.S.C.). The grids import data from the Control & Feedback Software Chart (C.F.S.C.) and the Control & Feedback Balance Sheet Computation. The 3D Land-Use Control Grid (3D C.G.) computes all the data: to monitor the Operational Specification Charts (O.S.C.); to highlight errors, obsolescence or rejection of a service applied to the model to correct any dysfunctions; to validate the conformity of the proposed correction(s) to the model; to provide feedback from the correction reintegration; and to modify the planning of evolution and reintegrate the correction at the most upward phases of the software suite. Virtual reality images can be provided from the 3D Land-Use Controls Grid, and the monitoring, correction, and conformity. Feedback and/or integration aspects can be highlighted.

The following provides a list of acronyms used throughout this disclosure for the various charts, grids and balance sheets, etc.

LIST OF ACRONYMS

| | |
|---|---|
| 3D | 3 Dimensional |
| C0 | Category 0 - Existing Services |
| C1 | Category 1 - Those that we know and will optimize |
| C2 | Category 2 -Those that we extrapolate from existing technologies and |
| | services |
| C3 | Category 3 - Future services, for example, those that we can only |
| | imagine |
| Q² | Qualitative & Quantitative |
| Charts | |
| A.S.C. | Assessment Specification Chart |
| C.F.S.C. | Control & Feedback Software Chart |
| C.P.C. | Communication Protocols Chart |
| E.S.C. | Evolution Specification Chart |
| I.C. | Implementation Chart |
| I.T.C. | Implementation Tender Chart |
| I.T.C.B. | Implementation Tender Chart Builder |
| I.T.C.O. | Implementation Tender Chart Operator |
| I.T.C.SP | Implementation Tender Chart Service Provider |
| M²C | Management & Maintenance Chart |
| MGC | Management Chart |
| Q² C.F.C.. | Q² Control & Feedback Chart |
| Q² I.C. | Q² Integration Chart |
| Q² O.S.C. | Q² Operational Specification Chart |
| Q².D.C. | Q² Dynamic Charter |
| Q².D.C.Mg.C | Q² Dynamic Charter Management Chart |
| Q².D.T.S.Mg.C | Q² Dynamic Transversal Service Management Chart |
| Q².F.C. | Q² Feedback Chart |
| Q².M.C. | Q² Monitoring Chart |
| Q².R.T.C.N.C. | Q² Real Time Computer Notification System Chart |
| Q².R.T.P.T.C.) | Q² Real Time Preventive Telemaintenance Chart |
| Q² S.C. | Q² Specification Chart |
| Q² A.S.C. | Q² Assessment Specification Chart |
| Q²C² | Q² Correction Chart |
| Q²C² | Q² Conformity Chart |
| Q²D.C.B.S.C. | Q² Dynamic Charter Balance Sheet Chart |
| Q²E.S.C. | Q² Evolution Specification Chart |
| Q²T.S.C. | Q² Theoretical Specification Chart |
| R.T.C.² | Real Time Corroboration Chart |
| R.T.V.C. | Real Time Validation Chart |
| R.T.V.C.B. | Real Time Validation Chart Builder |
| R.T.V.C.O.. | Real Time Validation Chart Operator |
| R.T.V.C.SP. | Real Time Validation Chart Service Provider |
| R.T.V.C². | Real Time Validation Chart Client |
| T.S.C. | Theoretical Specification Chart |
| Grids | |
| 3D C.G. | 3D Control Grid |
| 3D Tr.S.G. | 3D Trade Specification Grid |
| 3D.I.G. | 3D Implementation Grid |
| Q² A.G. | Q² Assessment Grid |
| Q².E.G. | Q² Evolution Grid |
| Balance Sheets | |
| C.F.B.S.C. | Control and Feedback Balance Sheet Computation |
| C².B.S.C. | Communication Balance Sheet Computation |
| I.B.S.C. | Implementation Balance Sheet Computation |
| MG.B.S.C | Management Balance Sheet Computation |
| MTB.S.C | Maintenance Balance Sheet Computation |
| MTC | Maintenance Chart |
| O.S.C. | Operational Specification Chart |
| Q² B.S.C | Q² Balance Sheet Computation |
| Q² C.F.B.S. | Q² Control & Feedback Balance Sheet |
| Tr.S.B.S.. | Trade Specification Balance Sheet |
| Tr.S.C. | Trade Specification Chart |
| Tr.S.C.B. | Trade Specification Chart Builder |
| Tr.S.C.O. | Trade Specification Chart Operator |
| Tr.S.C.O. | Trade Specification Chart Operator |
| Tr.S.C.SP | Trade Specification Chart Service Provider |
| Tr.S.C² | Trade Specification Chart Customer |

The inventions set forth above are subject to many modifications and changes without departing from the spirit, scope or essential characteristics thereof. Thus the embodiments explained above should be considered in all respect as being illustrative rather than restrictive of the scope of the inventions as defined in the appended claims.

In the claims:

1. A framework for optimizing use of resources in a physical space comprising:
links that link entities, having a relationship with a physical space, wherein the links define a relationship between two or more entities or between an entity and the physical space; and
a feedback loop that allows user input or consumer feedback to be used in order to optimize one of consumer satisfaction and quality of life, in services offered or proposed to be offered to consumers located in the physical space.

2. The framework of claim 1 wherein the framework comprises software and wherein the links are stored in one of: a database, a relational database, and hyperlink storage as hyperlinks.

3. The framework of claim 3 wherein the links have a bi-directional relationship.

4. The framework of claim 1 wherein the entities comprise one or more of private entities, public entities, physical infrastructure, organization infrastructure, surrounding environs of private, and publicly owned structures.

5. The framework of claim 4 wherein physical and organization infrastructure of the entities, comprise one or more of: buildings, equipment and other physical items as well as organizational structure, software, data, information, intellectual assets, and other intangibles.

6. The framework of claim 1 wherein the entities relationship with the physical space comprises one or more of: geographical, political, environmental, and/or business relationship.

7. The framework of claim 1 wherein the physical space is one of: land, sea, outer space, underwater, neighborhood, developed site, and undeveloped site.

8. The framework of claim 1 wherein the services are categorized and the framework further comprises a relational or other database to store services.

9. The framework of claim 1 wherein the services comprise: development, environment, security, information and communications, education, health care, cultural life and sport, and transportation services.

10. The framework of claim 1 wherein the services are characterized as human, economic, and environmental.

11. The framework of claim 1 wherein the framework is used on developed sites or on undeveloped sites.

12. The framework of claim 1 wherein the framework identifies and defines the links.

13. The framework of claim 1 wherein the framework comprises means for managing the links.

14. The framework of claim 1 further comprising a theoretical specification chart wherein a theoretical specification chart is created and used.

15. The framework of claim 14 further comprising a model wherein the theoretical specification is compared to the present land use.

16. The framework of claim 15 wherein the model highlights incompatible propositions with numeric imaging.

17. The framework of claim 15 further comprising a simulator wherein a simulation is created based on the model.

18. The framework of claim 1 further comprising a an operational specification chart which is created and used.

19. The framework of claim 1 further comprising a graphics program wherein a graphical representation is created and used.

20. The framework of claim 1 further comprising a 3D program wherein a 3D presentation is created and used.

21. The framework of claim 1 further comprising a virtual reality program wherein a virtual reality presentation is used.

22. The framework of claim 1 further comprising a three dimensional wherein the three dimensional grid is used for assessment of the services and the three axes represent x=human, y=economic, z=environmental.

23. The framework of claim 1 wherein the equation A+B−C<or=A is used for economic evaluation wherein A represents: the cost of existing services, B represents: the increased cost due to improving the service or services, and C represents: persons or entities concerned with:
C1—economy of scale realized when the serve is implemented,
C2—economy due to ‘intelligence’ in maintenance and operation of the service,
C3—qualitative increase in level and number of services,
C4—economic fall out of these improvement, and
C5—assurance for the operator to have a rapid return on the investment.

24. The framework of claim 1 wherein the equation A+B−C>A is used for economic evaluation.

25. A method for optimizing land and resource use, said method comprising the steps of:
gathering data, said data representative of human factors, economic factors and environmental factors;
qualitatively assessing said data;
quantitatively assessing said data;
developing a plan for optimal use of said land and resources, wherein said step of developing comprises determining a numerical representation or value of services, formulating a theoretical specification, and modeling said services and use of said land and resources; and
repeating said steps of gathering data, qualitatively assessing said data, quantitatively assessing said data, and developing a plan, wherein said step of repeating aids in creating an optimal land-use plan.

26. The method of claim 25, wherein the step of gathering comprises gathering customer feedback data.

27. The method of claim 25, wherein the step of gathering data comprises the step of populating a chart with the gathered data.

28. The method of claim 27, wherein the step of qualitatively assessing said data further comprises the step of assigning a value to the human factors, economic factors and environmental factors represented by said data.

29. The method of claim 28, wherein the step of gathering data further comprises the step of populating a balance sheet with the gathered data.

30. The method of claim 29, wherein the step of quantitatively assessing said data further comprises the step of performing calculations on said data to generate resultant data.

31. The method of claim 30, further comprising the step of:
importing said data and said assigned value from said chart to an assessment grid;
importing said resultant data from said balance sheet to said assessment grid; and
displaying said assessment grid, wherein said assessment grid represents the status of said services.

32. The method of claim 31, further comprising the step of:
modifying the numerical representation or value assigned to the services, thereby generating a modified value;
importing said data and said modified value from said chart to an evolution grid;
importing said resultant data from said balance sheet to said evolution grid; and
displaying said data and said modified value from said chart, and resultant data from said balance sheet, wherein said evolution grid represents the proposed status of said services.

33. The method of claim 32, further comprising the step of visually displaying a virtual representation of the optimal land-use plan.

34. The method of claim 33, wherein said assessment grid and said evolution grid have three axis, said three axis representative of said human factors, economic factors and environmental factors.

35. The method of claim 33, wherein said human factors are chosen from one of: smart growth & sustainable development, security, health care, education, environment, transportation, cultural life & sport, and information and communication.

36. The method of claim 33, wherein said economic factors are chosen from one of: studies and projections cost, realization cost, cost of debt, management, maintenance and control cost, tax revenues, yield and appropriation, sales price of services, and legal and particulars.

37. The method of claim 33, wherein said environmental factors are chosen from one of: water, air, noise level, soil—underground—relief, green spaces, public lighting, waste and treatment, and pollution.

38. The method of claim 25, wherein said method is implemented during one of: conceptualization of land use, implementation of land use, management and maintenance of land use, and control of land use.

39. The method of claim 38, wherein the step of developing is performed during one of: conceptualization of land use, implementation of land use, management and maintenance of land use, and control of land use.

40. The method of claim 25, wherein a charter is created.

41. The method of claim 25, wherein the proposed services are linked together in a network of links and the links are managed.

42. The method of claim 25, wherein said proposed services are chosen from one of: a bridge, a river, a street, streetlights, apartments, TV channels, agriculture, public health, a building, a city hall, the state, sports, a book, a field, offices, cattle, a forest, air and water quality, noise, a factory, a coast, and a hill.

43. The method of claim 25, wherein said step of developing a plan for optimal use of said land and resources, further includes the step of performing an economic selection by use of the equation A+B−C<or=A, wherein A represents: the cost of existing services, B represents: the increased cost due to improving the service or services, and C represents: persons or entities concerned with: C1—economy of scale realized when the serve is implemented, C2—economy due to ‘intelligence’ in maintenance and operation of the service, C3—qualitative increase in level and number of services, C4—economic fall out of these improvement, and C5—assurance for the operator to have a rapid return on the investment.

44. A computer-readable medium comprising instructions to:
gather data, said data representative of human factors, economic factors and environmental factors;
qualitatively assess said data;
quantitatively assess said data;
develop a plan for optimal use of land and resources, wherein the instructions to develop a plan comprise instructions for determining a numerical representation or value of services, formulating a theoretical specification, and modeling said services and use of said land and resources; and
repeat instructions to gather data, qualitatively assess said data, quantitatively assess said data, and develop a plan, wherein said repeat instructions aids in creating an optimal land-use plan.

45. The computer-readable medium of claim 44, wherein the instructions to gather data comprise gathering customer feedback data.

46. The computer-readable medium of claim 44, further comprising instructions to display the optimal land-use plan..
